(19) United States
(12) Patent Application Publication
(10) Pub. No.: US 2026/0050649 A1
(43) Pub. Date: Feb. 19, 2026

(54) ELECTRONIC APPARATUS AND CONTROLLING METHOD THEREOF

(71) Applicant: CRYPTO LAB INC., Seoul (KR)

(72) Inventor: Jai Hyun Park, Lyon (FR)

(21) Appl. No.: 19/195,603

(22) Filed: Apr. 30, 2025

(30) Foreign Application Priority Data
May 2, 2024 (KR) 10-2024-0058566
Apr. 29, 2025 (KR) 10-2025-0056688

(51) Int. Cl. G06F 17/16; G06F 7/523; H04L 9/00

(52) U.S. Cl. CPC G06F 17/16; G06F 7/523; H04L 9/008

(57) ABSTRACT

Provided is an electronic apparatus including: at least one processor including processing circuitry; and a memory storing instructions, wherein the at least one processor is configured to obtain an operation command for performing a first multiplication operation on a first ciphertext matrix and a second ciphertext matrix, obtain a third ciphertext matrix by applying a ciphertext matrix transpose (CMT) algorithm to the first ciphertext matrix, and obtain an operation result corresponding to the operation command by performing a second multiplication operation on a plurality of plaintext matrices based on the second ciphertext matrix and the third ciphertext matrix.

### TECHNICAL FIELD

The present disclosure relates to an electronic apparatus and a controlling method thereof, and more particularly, to an electronic apparatus for performing operations on a plurality of ciphertexts in a homomorphic encryption environment, and a controlling method thereof.

### BACKGROUND ART

As communication technology advances and electronic apparatuses become more widespread, continuous efforts are being made to ensure secure communication between the electronic apparatuses. Accordingly, encryption and decryption technologies are used in most communication environments.

If a message encrypted by the encryption technology is transmitted to the other party, the other party is required to perform decryption to use the message. In this case, the other party may waste resources and time in a process of decrypting encrypted data. In addition, the message may be easily leaked to a third party if the third party hacks the message while the other party temporarily decrypts the message for operation.

To address these issues, homomorphic encryption methods are being studied. Homomorphic encryption may obtain the same result as an encrypted value obtained after performing an operation on a plaintext, even if the operation is performed on a ciphertext itself obtained without decrypting encrypted information. Therefore, various operations may be performed without decrypting the ciphertext.

There have been recent efforts to utilize homomorphic ciphertexts in a large-scale language model (LLM) inference process, and the above-described inference process requires high-dimensional matrix multiplication.

Therefore, a method that may efficiently perform high-dimensional matrices using the homomorphic ciphertexts has been required.

High-dimensional matrix operations may be performed using ciphertext-ciphertext matrix multiplication (CCMM). The ciphertext-ciphertext matrix multiplication (CCMM) refers to a multiplication operation between ciphertexts and may thus require a lot of resources. The CCMM may be required to process a large amount of data, which may lead to prolonged processing times.

### DISCLOSURE OF INVENTION

### Solution to Problem

The present disclosure provides an electronic apparatus for reducing data processing by performing operations on plaintext based on ciphertext-ciphertext matrix multiplication (CCMM) of a plurality of ciphertexts, and a controlling method thereof.

According to an embodiment of the present disclosure, provided is an electronic apparatus including: at least one processor including processing circuitry; and a memory storing instructions, wherein the at least one processor is configured to obtain an operation command for performing a first multiplication operation on a first ciphertext matrix and a second ciphertext matrix, obtain a third ciphertext matrix by applying a ciphertext matrix transpose (CMT) algorithm to the first ciphertext matrix, and obtain an operation result corresponding to the operation command by performing a second multiplication operation on a plurality of plaintext matrices based on the second ciphertext matrix and the third ciphertext matrix.

The ciphertext matrix transpose (CMT) algorithm may be an algorithm for transforming row-based data into column-based data or vice versa.

The first ciphertext matrix may include a first plaintext matrix, a first Toeplitz (Toep) matrix, and a second plaintext matrix, and the second ciphertext matrix may include a third plaintext matrix, the first Toeplitz matrix, and a fourth plaintext matrix.

The at least one processor may be configured to obtain the third ciphertext matrix, which includes the first plaintext matrix, the second plaintext matrix, and a second Toeplitz matrix by applying the ciphertext matrix transpose (CMT) algorithm to the first ciphertext matrix.

The first Toeplitz matrix and the second Toeplitz matrix may be matrices having the same values in a predetermined diagonal direction.

The first Toeplitz matrix may be a matrix generated based on a first secret key. The second secret key may be a key that is an automorphism of the first secret key.

The at least one processor may be configured to obtain the operation result by performing the second multiplication operation on at least two plaintext matrices among the first plaintext matrix, the second plaintext matrix, the third plaintext matrix, and the fourth plaintext matrix.

The at least one processor may be configured to obtain a first data group based on the second ciphertext matrix and the third ciphertext matrix, and the first data group may include first data, second data, third data, and fourth data, the first data including the second Toeplitz matrix, the first plaintext matrix, the third plaintext matrix, and the first Toeplitz matrix, the second data including the second Toeplitz matrix, the first plaintext matrix, and the fourth plaintext matrix, the third data including the second plaintext matrix, the third plaintext matrix, and the first Toeplitz matrix, and the fourth data including the second plaintext matrix and the fourth plaintext matrix.

The at least one processor may be configured to obtain a fifth plaintext matrix by multiplying the first plaintext matrix with the third plaintext matrix, obtain a sixth plaintext matrix by multiplying the first plaintext matrix with the fourth plaintext matrix, obtain a seventh plaintext matrix by multiplying the second plaintext matrix with the third plaintext matrix, obtain an eighth plaintext matrix by multiplying the second plaintext matrix with the fourth plaintext matrix, and obtain a second data group based on the fifth plaintext matrix, the sixth plaintext matrix, the seventh plaintext matrix, and the eighth plaintext matrix, and the second data group may include fifth data, sixth data, seventh data, and eighth data, the fifth data including the second Toeplitz matrix, the fifth plaintext matrix, and the first Toeplitz matrix, the sixth data including the second Toeplitz matrix and the sixth plaintext matrix, the seventh data including the seventh plaintext matrix and the first Toeplitz matrix, and the eighth data including the eighth plaintext matrix.

According to an embodiment of the present disclosure, provided is a controlling method of an electronic apparatus, the method including: obtaining an operation command for performing a first multiplication operation on a first ciphertext matrix and a second ciphertext matrix; obtaining a third ciphertext matrix by applying a ciphertext matrix transpose (CMT) algorithm to the first ciphertext matrix; and obtaining an operation result corresponding to the operation command by performing a second multiplication operation on a plurality of plaintext matrices based on the second ciphertext matrix and the third ciphertext matrix.

The ciphertext matrix transpose (CMT) algorithm may be an algorithm for transforming row-based data into column-based data or vice versa.

The first ciphertext matrix may include a first plaintext matrix, a first Toeplitz (Toep) matrix, and a second plaintext matrix, and the second ciphertext matrix may include a third plaintext matrix, the first Toeplitz matrix, and a fourth plaintext matrix.

In the obtaining of the third ciphertext matrix, the third ciphertext matrix, which includes the first plaintext matrix, the second plaintext matrix, and a second Toeplitz matrix may be obtained by applying the ciphertext matrix transpose (CMT) algorithm to the first ciphertext matrix.

The first Toeplitz matrix and the second Toeplitz matrix may be matrices having the same values in a predetermined diagonal direction.

The first Toeplitz matrix may be a matrix generated based on a first secret key.

The second secret key may be a key that is an automorphism of the first secret key.

In the obtaining of the operation result, the operation result may be obtained by performing the second multiplication operation on at least two plaintext matrices among the first plaintext matrix, the second plaintext matrix, the third plaintext matrix, and the fourth plaintext matrix.

In the obtaining of the operation result, a first data group may be obtained based on the second ciphertext matrix and the third ciphertext matrix, and the first data group may include first data, second data, third data, and fourth data, the first data including the second Toeplitz matrix, the first plaintext matrix, the third plaintext matrix, and the first Toeplitz matrix, the second data including the second Toeplitz matrix, the first plaintext matrix, and the fourth plaintext matrix, the third data including the second plaintext matrix, the third plaintext matrix, and the first Toeplitz matrix, and the fourth data including the second plaintext matrix and the fourth plaintext matrix.

In the obtaining of the operation result, a fifth plaintext matrix may be obtained by multiplying the first plaintext matrix with the third plaintext matrix, a sixth plaintext matrix may be obtained by multiplying the first plaintext matrix with the fourth plaintext matrix, a seventh plaintext matrix may be obtained by multiplying the second plaintext matrix with the third plaintext matrix, an eighth plaintext matrix may be obtained by multiplying the second plaintext matrix with the fourth plaintext matrix, and a second data group may be obtained based on the fifth plaintext matrix, the sixth plaintext matrix, the seventh plaintext matrix, and the eighth plaintext matrix, and the second data group may include fifth data, sixth data, seventh data, and eighth data, the fifth data including the second Toeplitz matrix, the fifth plaintext matrix, and the first Toeplitz matrix, the sixth data including the second Toeplitz matrix and the sixth plaintext matrix, the seventh data including the seventh plaintext matrix and the first Toeplitz matrix, and the eighth data including the eighth plaintext matrix.

### BRIEF DESCRIPTION OF DRAWINGS

FIG. 1 is a diagram for describing a structure of a network system according to an embodiment.

FIG. 2 is a diagram for describing a structure of a network system according to an embodiment.

FIG. 3 is a block diagram for describing a configuration of an electronic apparatus according to an embodiment.

FIG. 4 is a diagram for describing ciphertext-ciphertext matrix multiplication (CCMM) according to an embodiment.

FIG. 5 is a diagram for describing ciphertext-ciphertext matrix multiplication (CCMM) according to an embodiment.

FIG. 6 is a diagram for describing a ciphertext matrix transpose (CMT) algorithm according to an embodiment.

FIG. 7 is a diagram for describing an operation for obtaining an operation result by reconstructing a ciphertext according to an embodiment.

FIG. 8 is a diagram for describing an operation for performing a plaintext-plaintext matrix multiplication (PPMM) by transforming a ciphertext-ciphertext matrix multiplication (CCMM) according to an embodiment.

FIG. 9 is a diagram for describing an operation for obtaining a final operation result by using the ciphertext matrix transpose (CMT) algorithm according to an embodiment.

FIG. 10 is a diagram for describing an operation for obtaining an operation result for the plurality of ciphertexts according to an embodiment.

FIG. 11 is a diagram for describing an operation performed on ciphertext according to an embodiment.

### MODE FOR INVENTION

Hereinafter, the embodiments of the present disclosure are described in detail with reference to the accompanying drawings.

General terms that are currently widely used are selected as terms used in embodiments of the present disclosure in consideration of their functions in the present disclosure, and may be changed based on the intention of those skilled in the art or a judicial precedent, the emergence of a new technique, or the like. In addition, in a specific case, terms arbitrarily chosen by an applicant may exist. In this case, the meanings of such terms are mentioned in detail in corresponding descriptions of the present disclosure. Therefore, the terms used in the present disclosure need to be defined on the basis of the meanings of the terms and the contents throughout the present disclosure rather than simple names of the terms.

In the present disclosure, an expression “have”, “may have”, “include”, “may include” or the like, indicates existence of a corresponding feature (for example, a numerical value, a function, an operation or a component such as a part), and does not exclude existence of an additional feature.

An expression, “at least one of A or/and B” may indicate either “A or B”, or “both of A and B.”

Expressions “first”, “second” and the like, used in the present disclosure may indicate various components regardless of the sequence or importance of the components. The expression is used only to distinguish one component from another component, and does not limit the corresponding component.

If any component (for example, a first component) is mentioned to be “(operatively or communicatively) coupled with/to” or “connected to” another component (for example, a second component), it should be understood that the any component is directly coupled to another component or may be coupled to another component through yet another component (for example, a third component).

A term of a singular number may include its plural number unless explicitly indicated otherwise in the context. It should be understood that a term “include” or “have” used in this application specifies the presence of features, numerals, steps, operations, components, parts, or combinations thereof, which are mentioned in the specification, and does not preclude the presence or addition of one or more other features, numerals, steps, operations, components, parts, or combinations thereof.

In the present disclosure, a “module” or a “˜er/˜or” may perform at least one function or operation, and be implemented by hardware, software, or a combination of hardware and software. In addition, a plurality of “modules” or a plurality of “˜ers/˜ors” may be integrated in at least one module and be implemented by the processor (not shown) except for a “module” or a “˜er/or” that needs to be implemented by a specific hardware.

In the specification, such a term as a “user” may refer to a person who uses the electronic apparatus or an apparatus (for example, an artificial intelligence electronic apparatus) which uses the electronic apparatus.

In addition, in the present disclosure, a “value” may be defined as a concept that includes a vector as well as a scalar value.

Mathematical operations and calculations in each step of the present disclosure described below may be implemented as computer operations by a known coding method and/or coding designed to be appropriate for the present disclosure to perform the corresponding operations or calculations.

Specific equations described below are illustratively provided among possible alternatives, and the scope of the present disclosure should not be construed as being limited to the equations mentioned in the present disclosure.

For convenience of description, the present disclosure defines the following notations,
a←D: Select an element a based on distribution D.
s₁, s₂ ∈R: Each of s₁, s₂ is an element belonging to a set R.
mod(q): Perform a modular operation with an element q.
└·┐: Round an internal value.

Hereinafter, various embodiments of the present disclosure are described in detail with reference to the accompanying drawings.

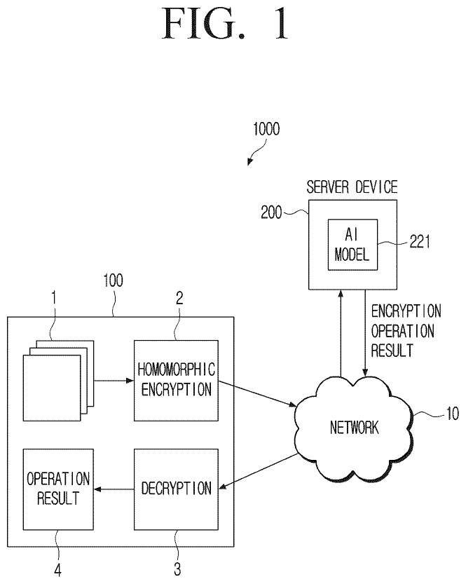

FIG. 1 is a diagram for describing a structure of a network system 1000 according to an embodiment.

Referring to FIG. 1, an electronic apparatus 100 and a server device 200 may communicate with each other via a network 10. The network 10 may be implemented as any of various forms of wired/wireless communication networks, a broadcast communication network, an optical communication network, a cloud communication network or the like, and the respective devices may be connected to one another without a separate medium, such as wireless fidelity (Wi-Fi), Bluetooth, or Near Field Communication (NFC).

FIG. 1 shows one electronic apparatus 100. However, the electronic apparatus 100 may be implemented in a variety of different types. For example, the electronic apparatus 100 may be implemented in various forms of devices such as a smartphone, a tablet, a personal computer (PC), a laptop PC, a home server, a kiosk, a game player, or a camera. In addition, the electronic apparatus 100 may be implemented as a home appliance to which an internet of things (IoT) functions is applied.

For example, if the electronic apparatus 100 includes a camera, the electronic apparatus 100 may directly capture and obtain at least one original data 1. If the electronic apparatus 100 includes no camera, the electronic apparatus 100 may receive and store the original data 1 from an external device (e.g., a camera or a memory stick) through various wired or wireless interfaces. In various embodiments of the present disclosure, the original data 1 may be a photographic image, is not necessarily limited thereto, and may be a graphic image. Alternatively, the original data 1 may be a video content including a plurality of image frames.

The electronic apparatus 100 may perform homomorphic encryption 2 on at least one original data to obtain a homomorphic ciphertext and then transmit the homomorphic ciphertext to the server device 200 via the network 10.

In this case, the original data 1 may be hacked and leaked to the outside during a transmission process, or may be leaked by an administrator of the server device 200. However, if the original data is transmitted in the form of the homomorphic ciphertext, the original data is unable to be identified even if the original data is leaked to the outside. Therefore, the security of the personal information or physical characteristics of a user may be strengthened.

A variety of homomorphic encryption algorithms for generating the homomorphic ciphertext may be provided. However, the various embodiments of the present disclosure describe a case where the homomorphic encryption is performed using a Cheon-Kim-Kim-Song (CKKS) Scheme or a modified algorithm based thereon.

The electronic apparatus 100 may perform encoding to transmit the original data in the form of homomorphic ciphertext. In the homomorphic encryption, the encoding refers to a task of converting data into an encryptable form. The homomorphic encryption is based on a mathematical structure (e.g., a polynomial operation), the homomorphic encryption algorithm may be used to convert the original data 1 into a form in which the original data 1 may be processed, and the homomorphic encryption may then be performed.

The homomorphic encryption may commonly use slot encoding and coefficient encoding methods.

The slot encoding refers to a method for allocating data to be encrypted to a plurality of slots and then encoding the same in units of all slots. A slot refers to a data unit in which the data may be stored in parallel in one homomorphic ciphertext. If the ciphertext is expressed in the polynomial form, the coefficients or roots of a polynomial may serve as each slot. If one ciphertext includes a total of n slots, n values may be encoded or operated on simultaneously. That is, if the slot encoding is performed, parallel operations (parallel computations) may be performed on the homomorphic ciphertext. The slot encoding method may vary depending on the homomorphic encryption algorithm. The above-described CKKS scheme may perform the slot encoding by using a fast Fourier transform (FFT).

The coefficient encoding refers to a method for converting the data to be encrypted into the polynomial form and converting the coefficients of the polynomial into encrypted values. The CKKS scheme described above may perform the coefficient encoding by using a discrete Fourier Transform (DFT).

According to an embodiment of the present disclosure, the electronic apparatus 100 may perform chunked-in-slot (CinS) encoding. The CinS encoding refers to a method for performing the slot encoding and then performing the DFT on a plurality of slot sections instead of the entire slot. This configuration is described in detail in a description provided below.

Data encoded using the CinS encoding method is referred to as CinS encoded data in the present disclosure. The electronic apparatus 100 may transmit the homomorphic ciphertext obtained by performing the homomorphic encryption 2 on the CinS encoded data to the server device 200.

The server device 200 refers to a device for performing an operation on the homomorphic ciphertext (i.e., at least one original data that is homomorphically encrypted) provided from the electronic apparatus 100 in a homomorphically encrypted state and providing an encryption operation result. The server device 200 may be implemented in any of various forms, such as a web server or a cloud server.

The server device 200 may store an artificial intelligence (AI) model 221 for performing an operation in the encrypted state. As described above, in the case where the original data is provided and an operation is to be performed based on the original data, the AI model 221 may be a convolutional neural network (CNN), and is not necessarily limited thereto.

Specifically, the AI model 221 may perform various operations on the homomorphic ciphertext encrypted using homomorphic encryption technology (e.g., the CKKS Scheme) and output an operation result in the form of homomorphic ciphertext. Hereinafter, the operation result output in the form of homomorphic ciphertext is referred to as the encryption operation result.

If the AI model 221 is configured as the CNN, the AI model 221 included in the server device 200 may perform a depth-based convolution operation or a convolution operation on the homomorphic ciphertext transmitted from the electronic apparatus 100 by using model parameters. A description of this operation method is specifically described below.

The server device 200 may transmit the encryption operation result to the electronic apparatus 100 via the network 10. The electronic apparatus 100 may perform decryption 3 on the received encryption operation result and provide an operation result 4 to a user. A method for providing the result may vary depending on the type and configuration of the electronic apparatus 100.

For example, if the electronic apparatus 100 has an embedded display or is connected to an external display (e.g., a monitor), the electronic apparatus 100 may display a decryption operation result 4.

For example, if the electronic apparatus 100 includes a speaker, the electronic apparatus 100 may output a voice message corresponding to the operation result through the speaker.

For example, if the electronic apparatus 100 performs communication with another terminal device (e.g., the smartphone), the electronic apparatus 100 may transmit the decrypted operation result to the terminal device.

For example, if the AI model 221 is a model trained to diagnose a disease, the operation result may include information about the presence or absence of the disease, a type of disease, and a progress of the disease diagnosed based on the original data 1 of the user.

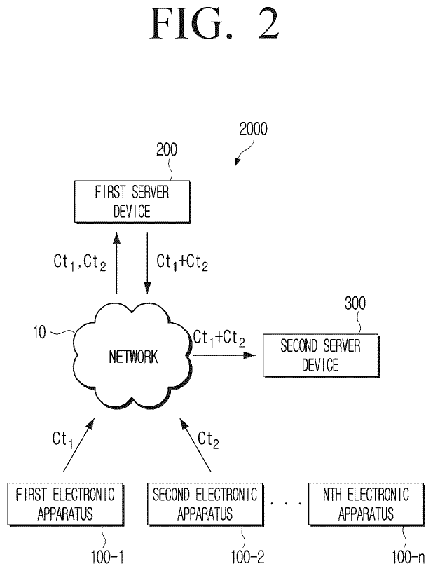

FIG. 2 is a diagram for describing a structure of a network system 2000 according to an embodiment.

Referring to FIG. 2, the network system may include a plurality of electronic apparatuses 100-1 to 100-n, a first server device 200, and a second server device 300, and the respective components may be connected to one another via the network 10.

The network 10 may be implemented as any of various forms of wired/wireless communication networks, a broadcast communication network, an optical communication network, a cloud communication network or the like, and the respective devices may be connected to one another without a separate medium, such as wireless fidelity (Wi-Fi), Bluetooth, or Near Field Communication (NFC).

FIG. 2 shows that the plurality of electronic apparatuses 100-1 to 100-n are provided. However, the plurality of electronic apparatuses are not necessarily required to be used, and a single apparatus may be used instead. For example, the electronic apparatuses 100-1 to 100-n may be implemented in various forms of apparatuses such as smartphones, tablets, game players, personal computers (PCs), laptop PCs, home servers, or kiosks, and may also be implemented in the form of home appliances using Internet of Things (IoT) functions.

The user may input various information by using the electronic apparatuses 100-1 to 100-n that the user uses. The input information may be stored in the electronic apparatuses 100-1 to 100-n themselves, or may also be transmitted to and stored in an external device for reasons such as storage capacity and security. As shown in FIG. 2, the first server device 200 may serve to store such information, and the second server device 300 may serve to utilize some or all of the information stored in the first server device 200.

Each of the electronic apparatuses 100-1 to 100-n may homomorphically encrypt the input information and transmit a homomorphic ciphertext to the first server device 200.

Each of the electronic apparatuses 100-1 to 100-n may include an error, i.e., encryption noise calculated in a process of performing homomorphic encryption, in the ciphertext. Specifically, the homomorphic ciphertext generated by each of the electronic apparatuses 100-1 to 100-n may be generated in a form in which a result value including a message and an error value is restored if the homomorphic ciphertext is decrypted later utilizing a secret key.

For example, the homomorphic ciphertext generated by each of the electronic apparatuses 100-1 to 100-n may be generated in a form that satisfies the following property if decrypted using the secret key.

$$Dec ( ct , sk ) = 〈 ct , sk 〉 = M + e ( mod q ) \qquad [ Equation l ]$$

Here, < and > indicate dot product operation (or usual inner product), ct indicates the ciphertext, sk indicates the secret key, M indicates a plaintext message, e indicates the encryption error value, and mod q indicates a ciphertext modulus. q needs to be selected to be larger than a result value M multiplied by a scaling factor Δ to the message. If an absolute value of the error value e is sufficiently smaller than M, a decrypted value M+e of the ciphertext may be a value that may replace an original message by the same precision in a significant figure operation. Among decrypted data, the error may be disposed on the least significant bit (LSB) side, and M may be disposed on the next least significant bit side.

If a message size is too small or too large, the size may be adjusted using the scaling factor. If the scaling factor is used, not only a message in an integer form but also a message in a real number form may be encrypted, and its usability may thus be greatly increased. In addition, the message size may be adjusted using the scaling factor to thus also adjust a size of an effective region, that is, a region where the messages are present in the ciphertext after the operation is performed.

In some embodiments, the ciphertext modulus q may be set and used in various forms. For example, the ciphertext modulus may be set in a form of an exponential power q=Δ^{L} of the scaling factor Δ. If Δ is 2, the modulus may be set to a value such as q=2¹⁰.

In addition, the homomorphic ciphertext according to the present disclosure is described assuming that fixed point-numbers are used. However, the homomorphic ciphertext may also be applied even to a case where floating-point numbers are used.

The first server device 200 may store the received homomorphic ciphertext in a ciphertext state without decrypting the ciphertext.

The second server device 300 may request a specific processing result for the homomorphic ciphertext from the first server device 200. The first server device 200 may perform a specific operation based on the request from the second server device 300 and then transmit its result to the second server device 300.

For example, if ciphertexts ct1 and ct2 transmitted from the two electronic apparatuses 100-1 and 100-2 are stored in the first server device 200, the second server device 300 may request the first server device 200 for a value obtained by combining information provided by the two electronic apparatuses 100-1 and 100-2. The first server device 200 can perform an operation for adding the two ciphertexts based on the request and then transmit a result value (ct1+ct2) to the second server device 300.

Due to a property of the homomorphic ciphertext, the first server device 200 may perform the operation without decrypting the ciphertext, and the result value may also be generated in a ciphertext form. In the present disclosure, the result value obtained using the operation is referred to as an operation result ciphertext.

The first server device 200 may transmit the operation result ciphertext to the second server device 300. The second server device 300 may decrypt the received operation result ciphertext to thus acquire the operation result value of data included in each homomorphic ciphertext.

Meanwhile, the electronic apparatus 100 may acquire the homomorphic ciphertext by using a residual number system (RNS) modulus including the plurality of moduli each having a size corresponding to a word size of the electronic apparatus 100, and use rational rescaling, thereby performing an operation on the homomorphic ciphertext. In at least one embodiment, the plurality of moduli may include sprout moduli formed by a product of prime numbers each having a size less than or equal to the word size, and the electronic apparatus 100 may perform various operations (e.g., key switching operation) on the homomorphic ciphertext by using the sprout modulus. In one or more embodiments, the electronic apparatus 100 may perform the key switching operation on the homomorphic ciphertext by upscaling the RNS modulus to generate an intermediate modulus, performing the key switching operation on the intermediate modulus, and performing rescaling on the intermediate modulus on which the key switching operation is performed.

In this way, the electronic apparatus 100 may perform efficient multiplication operations while minimizing the number of RNS moduli, thereby enabling faster operations on the homomorphic ciphertext.

Meanwhile, FIG. 2 shows a case where the encryption is performed by the first electronic apparatus and the second electronic apparatus, and the second server device performs the decryption, and the present disclosure is not necessarily limited thereto.

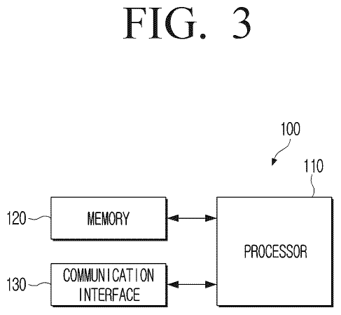

FIG. 3 is a block diagram for describing a configuration of the electronic apparatus according to an embodiment.

Referring to 3, the electronic apparatus 100 may include a memory 120 storing at least one processor 110 including processing circuitry and instructions. At least one processor 110 may perform the following operations by performing the instructions.

At least one processor 110 may obtain an operation command for performing a first multiplication operation on a first ciphertext matrix c1 and a second ciphertext matrix c2.

For example, the first multiplication operation may include ciphertext-ciphertext matrix multiplication (CCMM).

At least one processor 110 may receive the operation command from the external device or the user.

For example, the electronic apparatus 100 may include a communication interface 130. At least one processor 110 may receive the operation command or a plurality of ciphertexts that are targets of the operation command via the communication interface 130. The plurality of ciphertexts may include the first ciphertext matrix c1 and the second ciphertext matrix c2.

At least one processor 110 may obtain a third ciphertext matrix c3 by applying a ciphertext matrix transpose (CMT) algorithm to the first ciphertext matrix c1.

The ciphertext matrix transpose (CMT) algorithm may be an algorithm for transforming row-based data into column-based data or vice versa.

The ciphertext matrix transpose (CMT) algorithm may be an algorithm for transposing a matrix included in the ciphertext in a homomorphic encryption environment.

The ciphertext matrix transpose (CMT) algorithm may be an algorithm for reconstructing the ciphertext by performing a matrix transpose operation.

At least one processor 110 may apply the ciphertext matrix transpose (CMT) algorithm to the first ciphertext matrix c1. At least one processor 110 may not apply the ciphertext matrix transpose (CMT) algorithm to the second ciphertext matrix c2.

At least one processor 110 may obtain the third ciphertext matrix c3 by applying the ciphertext matrix transpose (CMT) algorithm to the first ciphertext matrix c1.

At least one processor 110 may obtain an operation result corresponding to the operation command by performing a second multiplication operation on a plurality of plaintext matrices based on the second ciphertext matrix c2 and the third ciphertext matrix c3.

At least one processor 110 may perform the second multiplication operation on the third ciphertext matrix c3 and the second ciphertext matrix c2.

For example, the second multiplication operation may include plaintext-plaintext matrix multiplication (PPMM).

At least one processor 110 may identify matrix structures of the second ciphertext matrix c2 and the third ciphertext matrix c3. At least one processor 110 may identify whether a multiplication operation on the plaintext matrices is possible based on the identified matrix structures.

At least one processor 110 may perform the multiplication operation on the identified plaintext matrices. At least one processor 110 may perform the plaintext-plaintext matrix multiplication (PPMM) on consecutive plaintext matrices if the plaintext matrices are consecutive in the matrix structure.

At least one processor 110 may obtain the first ciphertext matrix c1 and the second ciphertext matrix c2.

The first ciphertext matrix c1 may include a first plaintext matrix p1, a first Toeplitz (Toep) matrix, and a second plaintext matrix p2.

The second ciphertext matrix c2 may include a third plaintext matrix p3, a first Toeplitz matrix t1, and a fourth plaintext matrix p4.

At least one processor 110 may obtain the third ciphertext matrix c3, which includes the first plaintext matrix p1, the second plaintext matrix p2, and a second Toeplitz matrix t2 by applying the ciphertext matrix transpose (CMT) algorithm to the first ciphertext matrix c1.

The first Toeplitz matrix t1 and the second Toeplitz matrix t2 may be matrices having the same values in a predetermined diagonal direction.

The first Toeplitz matrix t1 may be a matrix generated based on a first secret key.

The second Toeplitz matrix t2 may be a matrix generated based on a second secret key that is different from the first secret key.

The second secret key may be a key that is an automorphism of the first secret key.

At least one processor 110 may obtain the operation result by performing the second multiplication operation on at least two plaintext matrices among the first plaintext matrix p1, the second plaintext matrix p2, the third plaintext matrix p3, and the fourth plaintext matrix p4.

At least one processor 110 may obtain a first data group 11 based on the second ciphertext matrix c2 and the third ciphertext matrix c3.

The first data group 11 may include first data d1, second data d2, third data d3, and fourth data d4.

The first data d1 may include the second Toeplitz matrix t2, the first plaintext matrix p1, the third plaintext matrix p3, and the first Toeplitz matrix t1.

The second data d2 may include the second Toeplitz matrix t2, the first plaintext matrix p1, and the fourth plaintext matrix p4.

The third data d3 may include the second plaintext matrix p2, the third plaintext matrix p3, and the first Toeplitz matrix t1.

The fourth data d4 may include the second plaintext matrix p2 and the fourth plaintext matrix p4.

At least one processor 110 may obtain a second data group 12 by performing the second multiplication operation on the plurality of plaintext matrices included in the first data group 11.

At least one processor 110 may obtain a fifth plaintext matrix p5 by multiplying the first plaintext matrix p1 with the third plaintext matrix p3.

At least one processor 110 may obtain a sixth plaintext matrix p6 by multiplying the first plaintext matrix p1 with the fourth plaintext matrix p4.

At least one processor 110 may obtain a seventh plaintext matrix p7 by multiplying the second plaintext matrix p2 with the third plaintext matrix p3.

At least one processor 110 may obtain an eighth plaintext matrix p8 by multiplying the second plaintext matrix p2 and the fourth plaintext matrix p4.

At least one processor 110 may obtain the second data group based on the fifth plaintext matrix p5, the sixth plaintext matrix p6, the seventh plaintext matrix p7, and the eighth plaintext matrix p8.

The second data group 12 may include fifth data d5, sixth data d6, seventh data d7, and eighth data d8.

The fifth data d5 may include the second Toeplitz matrix t2, the fifth plaintext matrix p5, and the first Toeplitz matrix t1.

The sixth data d6 may include the second Toeplitz matrix t2 and the sixth plaintext matrix p6.

The seventh data d7 may include the seventh plaintext matrix p7 and the first Toeplitz matrix t1.

The eighth data d8 may include the eighth plaintext matrix p8.

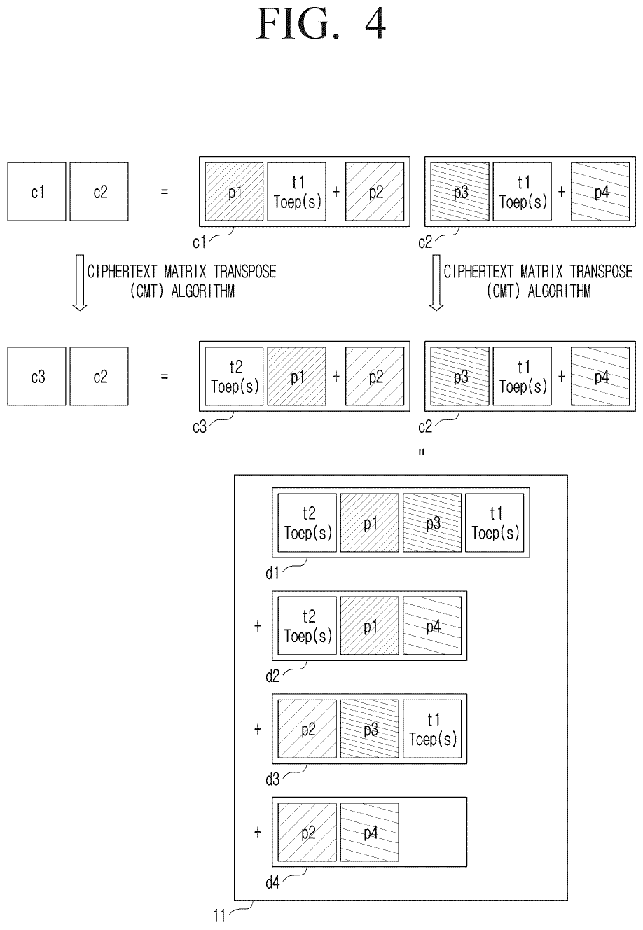

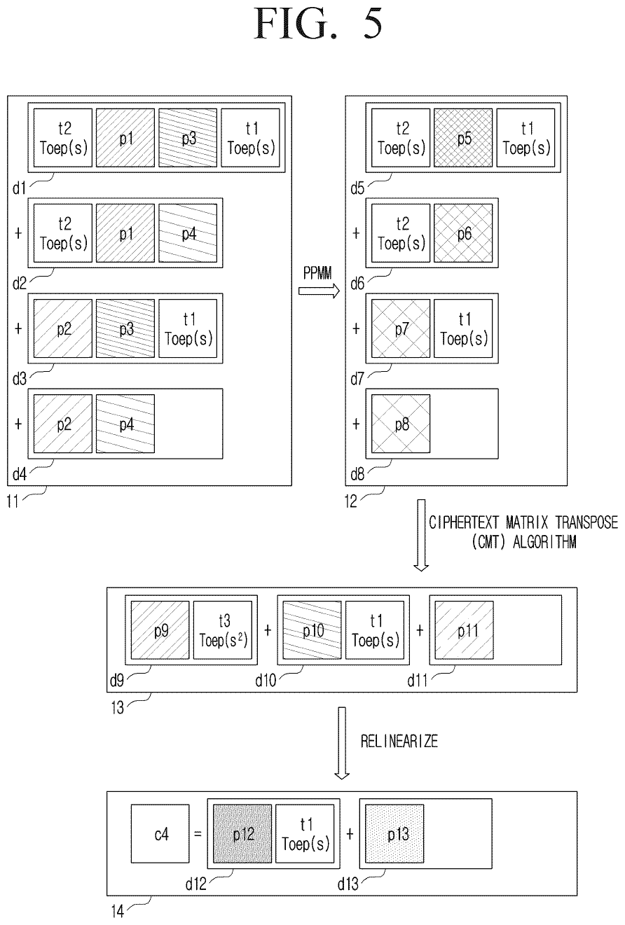

A description related to the above configuration is described with reference to FIGS. 4 and 5.

FIG. 4 is a diagram for describing the ciphertext-ciphertext matrix multiplication (CCMM) according to an embodiment.

Referring to FIG. 4, the electronic apparatus 100 may obtain the operation commands for the first ciphertext matrix c1 and the second ciphertext matrix c2.

The first ciphertext matrix c1 may include the first plaintext matrix p1, the first Toeplitz matrix t1, and the second plaintext matrix p2. The first ciphertext matrix c1 may represent a result of multiplying the first plaintext matrix p1 with the first Toeplitz matrix t1 and then adding the second plaintext matrix p2 thereto.

The second ciphertext matrix c2 may include the third plaintext matrix p3, the first Toeplitz matrix t1, and the fourth plaintext matrix p4. The second ciphertext matrix c2 may represent a result of multiplying the third plaintext matrix p3 with the first Toeplitz matrix t1 and then adding the fourth plaintext matrix p4 thereto.

The electronic apparatus 100 may simplify the ciphertext-ciphertext matrix multiplication (CCMM) into plaintext-plaintext matrix multiplication (PPMM) by using the ciphertext matrix transpose (CMT) algorithm.

The electronic apparatus 100 may apply the ciphertext matrix transpose (CMT) algorithm to the first ciphertext matrix c1.

Referring to FIGS. 4 and 5, the ciphertext matrix transpose (CMT) algorithm is described as being applied to the first ciphertext matrix c1. In some embodiments, the ciphertext matrix transpose (CMT) algorithm may be applied to the second ciphertext matrix c2.

The electronic apparatus 100 may obtain the third ciphertext matrix c3 by applying the ciphertext matrix transpose (CMT) algorithm to the first ciphertext matrix c1.

The third ciphertext matrix c3 may include the second Toeplitz matrix t2, the first plaintext matrix p1, and the second plaintext matrix p2. The third ciphertext matrix c3 may represent a result of multiplying the second Toeplitz matrix t2 with the first plaintext matrix p1 and then adding the second plaintext matrix p2 thereto.

The electronic apparatus 100 may obtain the second Toeplitz matrix t2 by applying the ciphertext matrix transpose (CMT) algorithm to the first ciphertext matrix c1.

The electronic apparatus 100 may obtain a product of the second Toeplitz matrix t2 with the first plaintext matrix p1 by applying the ciphertext matrix transpose (CMT) algorithm to the product of the third plaintext matrix p3 with the first Toeplitz matrix t1, included in the first ciphertext matrix c1.

The electronic apparatus 100 may obtain the second plaintext matrix p2 as it is even if the ciphertext matrix transpose (CMT) algorithm is applied to the second plaintext matrix p2.

The electronic apparatus 100 may perform the plaintext-plaintext matrix multiplication (PPMM) based on the second ciphertext matrix c2 and the third ciphertext matrix c3. The electronic apparatus 100 may obtain the first data group 11 based on the second ciphertext matrix c2 and the third ciphertext matrix c3.

The first data group 11 may include the first data d1, the second data d3, the third data d2, and the fourth data d4.

The first data d1 may include the second Toeplitz matrix t2, the first plaintext matrix p1, the third plaintext matrix p3, and the first Toeplitz matrix t1. For example, the first data d1 may represent a result of sequentially multiplying the second Toeplitz matrix t2, the first plaintext matrix p1, the third plaintext matrix p3, and the first Toeplitz matrix t1.

The second data d2 may include the second Toeplitz matrix t2, the first plaintext matrix p1, and the fourth plaintext matrix p4. For example, the second data d2 may represent a result of sequentially multiplying the second Toeplitz matrix t2, the first plaintext matrix p1, and the fourth plaintext matrix p4.

The third data d3 may include the second plaintext matrix p2, the third plaintext matrix p3, and the first Toeplitz matrix t1. For example, the third data d3 may represent a result of sequentially multiplying the second plaintext matrix p2, the third plaintext matrix p3, and the first Toeplitz matrix t1.

The fourth data d4 may include the second plaintext matrix p2 and the fourth plaintext matrix p4. The fourth data d4 may represent a result of sequentially multiplying the second plaintext matrix p2 with the fourth plaintext matrix p4.

FIG. 5 is a diagram for describing the ciphertext-ciphertext matrix multiplication (CCMM) according to an embodiment.

Referring to FIG. 5, the electronic apparatus 100 may perform a multiplication operation on plaintexts included in the first data group 11. The electronic apparatus 100 may use the ciphertext matrix transpose (CMT) algorithm to perform the plaintext-plaintext matrix multiplication (PPMM) instead of the ciphertext-ciphertext matrix multiplication (CCMM).

The electronic apparatus 100 may perform the plaintext-plaintext matrix multiplication (PPMM) on consecutive plaintexts in the first data group 11. The electronic apparatus 100 may obtain the second data group 12 by performing the plaintext-plaintext matrix multiplication (PPMM) on the first data group 11.

The electronic apparatus 100 may obtain the fifth plaintext matrix p5 by multiplying the first plaintext matrix p1 with the third plaintext matrix p3.

The electronic apparatus 100 may obtain the sixth plaintext matrix p6 by multiplying the first plaintext matrix p1 with the fourth plaintext matrix p4.

The electronic apparatus 100 may obtain the seventh plaintext matrix p7 by multiplying the second plaintext matrix p2 with the third plaintext matrix p3.

The electronic apparatus 100 may obtain the eighth plaintext matrix p8 by multiplying the second plaintext matrix p2 with the fourth plaintext matrix p4.

The second data group 12 may include the fifth data d5, the sixth data d6, the seventh data d8, and the eighth data d7.

The fifth data d5 may include the second Toeplitz matrix t2, the fifth plaintext matrix p5, and the first plaintext matrix p1. For example, the fifth data d5 may represent a result of sequentially multiplying the second Toeplitz matrix t2, the fifth plaintext matrix p5, and the first plaintext matrix p1.

The sixth data d6 may include the second Toeplitz matrix t2 and the sixth plaintext matrix p6. For example, the sixth data d6 may represent a result of sequentially multiplying the second Toeplitz matrix t2 with the sixth plaintext matrix p6.

The seventh data d7 may include the seventh plaintext matrix p7 and the first Toeplitz matrix t1. The seventh data d7 may represent a result of sequentially multiplying the seventh plaintext matrix p7 with the first Toeplitz matrix t1.

The eighth data d8 may include the eighth plaintext matrix p8.

The electronic apparatus 100 may perform an additional reconstruct operation on the second data group 12. The electronic apparatus 100 may obtain a third data group 13 by applying the ciphertext matrix transpose (CMT) algorithm to the second data group 12.

The third data group 13 may include ninth data d9, tenth data d10, and eleventh data d11.

The ninth data d9 may include a ninth plaintext matrix p9 and a third Toeplitz matrix t3. For example, the ninth data d9 may represent a result of sequentially multiplying the ninth plaintext matrix p9 with the third Toeplitz matrix t3.

For example, the fifth plaintext matrix p5 and the ninth plaintext matrix p9 may be the same as each other. The electronic apparatus 100 may maintain the fifth plaintext matrix p5 even if the ciphertext matrix transpose (CMT) algorithm is applied to the fifth data d5.

The third Toeplitz matrix t3 may be different from the first Toeplitz matrix t1 and the second Toeplitz matrix t2. The third Toeplitz matrix t3 may represent a matrix generated based on a third secret key. The third secret key may be different from the first secret key or the second secret key.

For example, the third secret key may be an automorphism of the second secret key. For example, the third secret key may be the square of the first secret key.

The tenth data d10 may include a tenth plaintext matrix p10 and the first Toeplitz matrix t1. The tenth data d10 may represent a result of sequentially multiplying the tenth plaintext matrix p10 with the first Toeplitz matrix t1.

For example, the tenth plaintext matrix p10) may represent a result of adding the sixth plaintext matrix p6 and the seventh plaintext matrix p7.

The eleventh data d11 may include an eleventh plaintext matrix p11.

For example, the eleventh plaintext matrix p11 may be the same as the eighth plaintext matrix p8.

The electronic apparatus 100 may apply a relinearization function to the third data group 13. The electronic apparatus 100 may obtain a fourth data group 14 by applying the relinearization function to the third data group 13. The electronic apparatus 100 may use the relinearization function to reduce a data size of a result for processing the ciphertext.

For example, a size of the fourth data group 14 may be smaller than a size of the third data group 13.

The fourth data group 14 may include twelfth data d12 and thirteenth data d13.

The twelfth data d12 may include a twelfth plaintext matrix p12 and the first Toeplitz matrix t1. The twelfth data d12 may represent a result of sequentially multiplying the twelfth plaintext matrix p12 with the first Toeplitz matrix t1.

The electronic apparatus 100 may obtain the twelfth plaintext matrix based on the ninth plaintext matrix p9 and the tenth plaintext matrix p10.

The thirteenth data d13 may include a thirteenth plaintext matrix p13.

For example, a size of the thirteenth plaintext matrix p13 may be smaller than a size of the eleventh plaintext matrix p11.

The fourth data group 14 may be a fourth ciphertext matrix c4. The fourth ciphertext matrix c4 may represent a final operation result corresponding to a multiplication instruction of the first ciphertext matrix c1 with the second ciphertext matrix c2. The fourth ciphertext matrix c4 may represent a final operation result corresponding to a multiplication instruction of the third ciphertext matrix c3 with the second ciphertext matrix c2.

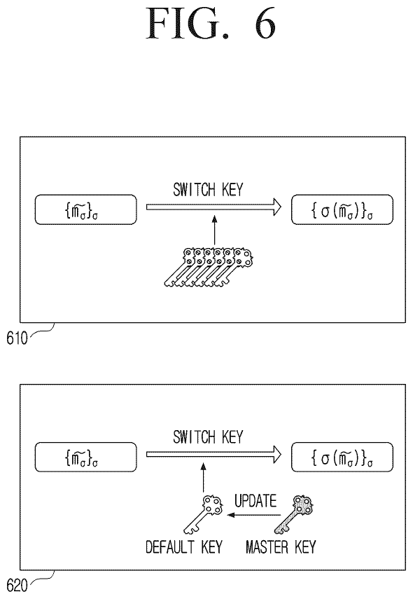

FIG. 6 is a diagram for describing the ciphertext matrix transpose (CMT) algorithm according to an embodiment.

If the transpose operation is performed on the ciphertext matrix, the plurality of Toeplitz matrices may be used. Examples of the plurality of Toeplitz matrices are described with reference to FIGS. 4 and 5. The plurality of Toeplitz matrices may be classified based on different keys. Here, the key corresponding to each of the plurality of Toeplitz matrices may be the automorphism.

The automorphism may include operations for transforming a specific target (e.g., the secret key) based on data included in the automorphism while maintaining its mathematical structure. For example, the electronic apparatus 100 may obtain the data based on the automorphism by using coefficients of a polynomial defining the specific target. The automorphism may represent an operation for rearranging exponents of the coefficients of the polynomial defining the specific target according to a predetermined rule.

Various methods for performing the automorphism operation may be provided.

According to Embodiment 610 shown in FIG. 6, the electronic apparatus 100 may perform an operation on the ciphertext matrix by using the plurality of secret keys. Each of the plurality of secret keys may be a pre-operated automorphism. The electronic apparatus 100 may store all the pre-operated plurality of secret keys.

If the plurality of secret keys are pre-stored, a lot of storage space may be required. In addition, resource usage of the electronic apparatus 100 may increase to process the operations on the plurality of secret keys. The reason is that all the secret keys are required to be prepared. If the plurality of secret keys are pre-stored, it may be difficult to change the secret key because the electronic apparatus 100 is required to use a pre-determined key value.

According to Embodiment 620 in FIG. 6, the electronic apparatus 100 may perform the operation on the ciphertext matrix by updating a default secret key (or a default key). The electronic apparatus 100 may generate a new secret key based on the automorphism by updating the default secret key. The electronic apparatus 100 may update the default secret key by using a predetermined number of master keys. The electronic apparatus 100 may generate the new secret key which is the automorphism of the default secret key by using the master key.

The electronic apparatus 100 may pre-store only the default secret key and the predetermined number of master keys. The electronic apparatus 100 may dynamically manage the secret key by updating the secret key in an actual ciphertext operation. Resource efficiency may be improved.

For example, the electronic apparatus 100 may store one default secret key and update the default secret key by using two master keys. The electronic apparatus 100 may obtain (or store) a first master key and a second master key. The first master key and the second master key may be keys used in an operation for generating the new secret key representing the automorphism of the default secret key.

The electronic apparatus 100 may generate the first Toeplitz matrix t1 by using one default secret key (the first secret key).

The electronic apparatus 100 may generate the second secret key and the third secret key based on at least one of the first master key or the second master key. For example, the electronic apparatus 100 may obtain the second secret key by updating the first secret key into the first master key. The electronic apparatus 100 may obtain the third secret key by updating the second secret key into the second master key.

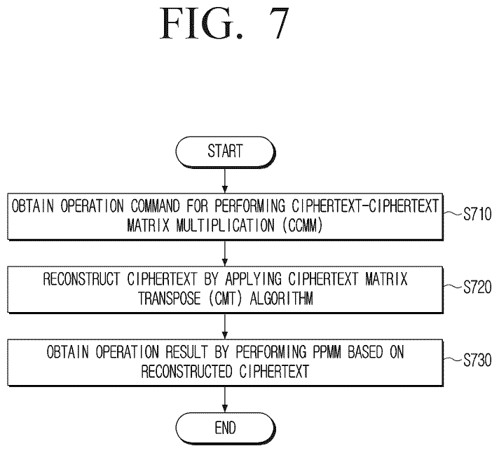

FIG. 7 is a diagram for describing an operation for obtaining the operation result by reconstructing the ciphertext according to an embodiment.

The electronic apparatus 100 may obtain the operation command for performing the ciphertext-ciphertext matrix multiplication (CCMM) (S710). The electronic apparatus 100 may receive the ciphertext from at least one external device. The electronic apparatus 100 may perform the multiplication operation on the plurality of ciphertexts received from at least one external device.

The electronic apparatus 100 has a high throughput for the ciphertext-ciphertext matrix multiplication (CCMM) operation, and may thus utilize the plaintext-plaintext matrix multiplication (PPMM) in some operations.

The electronic apparatus 100 may reconstruct the ciphertext to be operated by applying the ciphertext matrix transpose (CMT) algorithm to the ciphertext operation (S720). A reconstruction operation is described with reference to FIGS. 4 and 5.

The electronic apparatus 100 may obtain the operation result by performing the plaintext-plaintext matrix multiplication (PPMM) based on the reconstructed ciphertext (S730). The operation result may represent a value corresponding to the operation command in S1010. The electronic apparatus 100 may perform a multiplication operation for two or more plaintext matrices based on the reconstructed ciphertext.

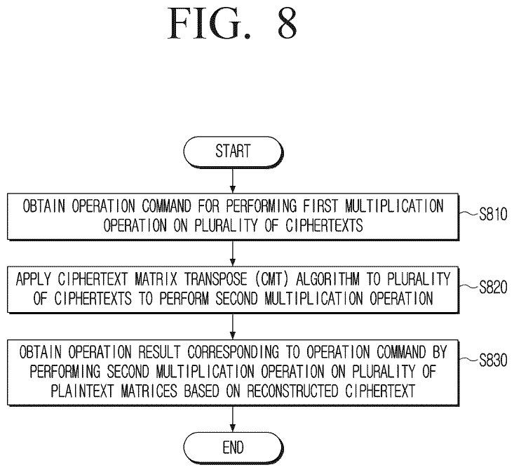

FIG. 8 is a diagram for describing an operation for performing the plaintext-plaintext matrix multiplication (PPMM) by transforming the ciphertext-ciphertext matrix multiplication (CCMM) according to an embodiment.

Referring to FIG. 8, the electronic apparatus 100 may obtain the operation command for performing the first multiplication operation on the plurality of ciphertexts (S810).

The electronic apparatus 100 may perform the second multiplication operation by applying the ciphertext matrix transpose (CMT) algorithm to the plurality of ciphertexts (S820). The electronic apparatus 100 may reconstruct at least one ciphertext by applying the ciphertext matrix transpose (CMT) algorithm to at least one ciphertext among the plurality of ciphertexts.

For example, the electronic apparatus 100 may apply the ciphertext matrix transpose (CMT) algorithm to all of the plurality of ciphertexts.

For example, the electronic apparatus 100 may apply the ciphertext matrix transpose (CMT) algorithm to at least some of the plurality of ciphertexts.

The electronic apparatus 100 may obtain the operation result corresponding to the operation command by performing the second multiplication operation on the plurality of plaintext matrices included in the reconstructed plurality of ciphertexts (or at least one reconstructed ciphertext) (S830).

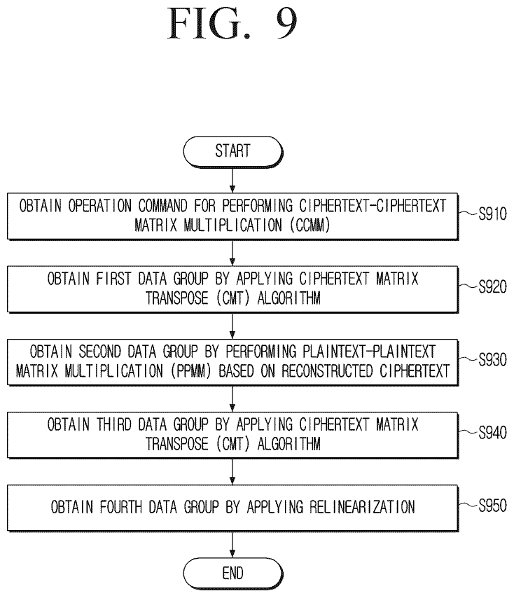

FIG. 9 is a diagram for describing an operation for obtaining the final operation result by using the ciphertext matrix transpose (CMT) algorithm according to an embodiment.

Referring to FIG. 9, the electronic apparatus 100 may obtain the operation command for performing the ciphertext-ciphertext matrix multiplication (CCMM) (S910). The electronic apparatus 100 may identify the plurality of ciphertexts that are operation targets of the ciphertext-ciphertext matrix multiplication (CCMM).

The electronic apparatus 100 may obtain the first data group by applying the ciphertext matrix transpose (CMT) algorithm to the identified plurality of ciphertexts (S920).

For example, the electronic apparatus 100 may apply the ciphertext matrix transpose (CMT) algorithm to all of the plurality of ciphertexts.

For example, the electronic apparatus 100 may apply the ciphertext matrix transpose (CMT) algorithm to at least some of the plurality of ciphertexts.

The electronic apparatus 100 may obtain the second data group by performing the plaintext-plaintext matrix multiplication (PPMM) based on the ciphertext reconstructed by applying the ciphertext matrix transpose (CMT) algorithm (S930).

The electronic apparatus 100 may obtain the third data group by applying the ciphertext matrix transpose (CMT) algorithm (S940). A description related to this configuration may refer to the third data group 13 shown in FIG. 5.

The electronic apparatus 100 may obtain the fourth data group by applying the relinearization (S950). A description related to this configuration may refer to the fourth data group 14 in FIG. 5.

The electronic apparatus 100 may obtain the fourth data group 14 as a final result corresponding to the operation command. The electronic apparatus 100 may provide (or return) the final result to a device (or the user) that requests the operation command.

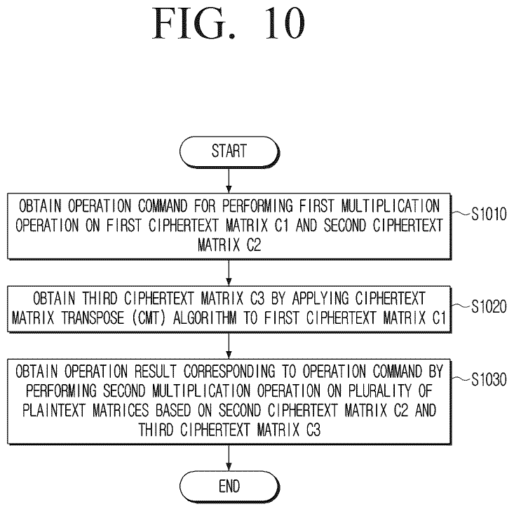

FIG. 10 is a diagram for describing an operation for obtaining the operation result for the plurality of ciphertexts according to an embodiment.

Referring to FIG. 10, a controlling method of an electronic apparatus 100 may include: obtaining the operation command for performing the first multiplication operation on the first ciphertext matrix and the second ciphertext matrix (S1010); obtaining the third ciphertext matrix by applying the ciphertext matrix transpose (CMT) algorithm to the first ciphertext matrix (S1020); and obtaining the operation result corresponding to the operation command by performing the second multiplication operation on the plurality of plaintext matrices based on the second ciphertext matrix and the third ciphertext matrix (S1030).

The ciphertext matrix transpose (CMT) algorithm may be the algorithm for transforming row-based data into column-based data or vice versa.

The first ciphertext matrix may include the first plaintext matrix, the first Toeplitz (Toep) matrix, and the second plaintext matrix, and the second ciphertext matrix may include the third plaintext matrix, the first Toeplitz matrix, and the fourth plaintext matrix.

In the obtaining of the third ciphertext matrix (S1020), the third ciphertext matrix, which includes the first plaintext matrix, the second plaintext matrix, and the second Toeplitz matrix may be obtained by applying the ciphertext matrix transpose (CMT) algorithm to the first ciphertext matrix.

The first Toeplitz matrix and the second Toeplitz matrix may be matrices having the same values in the predetermined diagonal direction.

The first Toeplitz matrix may be a matrix generated based on the first secret key.

The second secret key may be a key that is the automorphism of the first secret key.

In the obtaining of the operation result (S1030), the operation result may be obtained by performing the second multiplication operation on at least two plaintext matrices among the first plaintext matrix, the second plaintext matrix, the third plaintext matrix, and the fourth plaintext matrix.

In the obtaining of the operation result (S1030), the first data group may be obtained based on the second ciphertext matrix and the third ciphertext matrix, and the first data group may include the first data, the second data, the third data, and the fourth data, the first data including the second Toeplitz matrix, the first plaintext matrix, the third plaintext matrix, and the first Toeplitz matrix, the second data including the second Toeplitz matrix, the first plaintext matrix, and the fourth plaintext matrix, the third data including the second plaintext matrix, the third plaintext matrix, and the first Toeplitz matrix, and the fourth data including the second plaintext matrix and the fourth plaintext matrix.

In the obtaining of the operation result (S1030), the fifth plaintext matrix may be obtained by multiplying the first plaintext matrix with the third plaintext matrix, the sixth plaintext matrix may be obtained by multiplying the first plaintext matrix with the fourth plaintext matrix, the seventh plaintext matrix may be obtained by multiplying the second plaintext matrix with the third plaintext matrix, the eighth plaintext matrix may be obtained by multiplying the second plaintext matrix with the fourth plaintext matrix, and the second data group may be obtained based on the fifth plaintext matrix, the sixth plaintext matrix, the seventh plaintext matrix, and the eighth plaintext matrix, and the second data group may include the fifth data, the sixth data, the seventh data, and the eighth data, the fifth data including the second Toeplitz matrix, the fifth plaintext matrix, and the first Toeplitz matrix, the sixth data including the second Toeplitz matrix and the sixth plaintext matrix, the seventh data including the seventh plaintext matrix and the first Toeplitz matrix, and the eighth data including the eighth plaintext matrix.

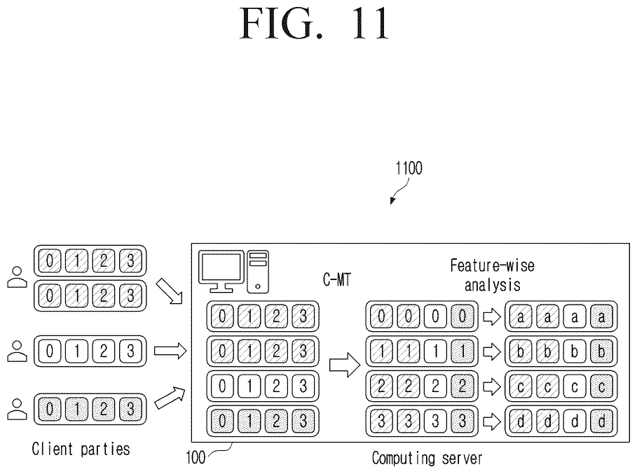

FIG. 11 is a diagram for describing the operation performed on the ciphertext according to an embodiment.

The matrix multiplication (CCMM) between two encrypted matrices is a key challenge for a privacy-preserving machine learning application.

Matrix multiplication (CCMM) between two encrypted matrices is a key challenge for a privacy-preserving machine learning application.

As modern machine learning models focus on scalability, fast CCMM on large datasets is increasingly in demand.

In this work, the disclosures present a CCMM algorithm for large matrices. The algorithm consists of plaintext matrix multiplications (PPMM) and the ciphertext matrix transpose algorithms (CMT). The disclosures propose a fast CMT algorithm, which is computationally inexpensive compared to PPMM.

By leveraging high-performance BLAS libraries to optimize PPMM, the disclosures implement large-scale CCMM with substantial performance improvements. Furthermore, the disclosures propose lightweight algorithms, significantly reducing the key size from 1 960 MB to 1.57 MB for CCMM with comparable efficiency.

In a single-thread implementation, the CMT algorithm takes 0.76 seconds to transpose a 2048×2048 encrypted matrix. The CCMM algorithm requires 85.2 seconds to multiply two 4096×4096 encrypted matrices. For large matrices, the present disclosure's algorithm outperforms the state-of-the-art CCMM method from Jiang-Kim-Lauter-Song [CCS'18] by a factor of over 800.

### 1 Introduction

The ciphertext-ciphertext matrix multiplication (CCMM) takes as input two bundles of the ciphertext(s) encrypting two input matrices and outputs the ciphertext(s) encrypting the product matrix. CCMM plays a central role in privacy-preserving machine learning (PPML) when a server trains or performs inference on machine learning models using encrypted data from the client. For example, during privacy-preserving training and inference of large language models (LLM) in [36, 24, 43], CCMM takes an important role.

As mentioned in [4], homomorphic multiplication with large matrices appears in various steps during PPML. The authors pointed out that the matrix dimension often ranges up to 16 384 (in GPT-3.5) and 18432 (in PaLM 540B) for privacy-preserving inference of LLMs. As the disclosures consider privacy-preserving training and inference of such LLMs, fast CCMM for large-dimensional matrices is necessary.

However, the existing CCMM algorithms are much slower than plaintext-plaintext matrix multiplication (PPMM) or plaintext-ciphertext matrix multiplication (PCMM). To take a notable example from [28], it takes 0.6 seconds to multiply two square matrices of dimension 64. To multiply square matrices of a larger dimension, 4096, for instance, would require more than 19 hours, even with the Strassen algorithm [40]. The disclosures note that most of the current CCMM implementations are based on [28] or its variants.

As a reference point, for plaintext-ciphertext matrix multiplication (PCMM), a recent work [4] significantly accelerated it to take 17.1 seconds to multiply square matrices of dimension 4096 in a single thread CPU. For plaintext-plaintext matrix multiplication (PPMM), by utilizing highly optimized linear algebra libraries (BLAS libraries), it takes 1.5 seconds for square matrices of dimension 4096. The inefficiency of CCMM has been one of the main bottlenecks for practical privacy-preserving training and inference of large neural networks, including LLMs such as GPT [38]. BERT and LLAMA [42].

The difficulty of CCMM stems from the complicated structure of the ciphertexts. State-of-the-art CCMM algorithms rely on fully homomorphic encryption (FHE) schemes based on the ring learning-with-error problem [39, 32] (RLWE). RLWE-based FHE schemes [8, 7, 18, 12] encrypt a vector in the ciphertext, requiring “key switching” operations to arrange the vector. Key switching operations during CCMM introduce computational overhead and disrupt the memory access pattern, significantly degrading the efficiency. Consequently. CCMM has been significantly slower than optimized PPMM implementations, such as those in BLAS libraries. This inefficiency becomes even more severe for large matrices, highlighting the need for more efficient CCMM algorithms for large matrices.

### 1.1 Contributions

The present disclosure's main result is a fast CCMM algorithm for large matrices. The algorithm focuses on matrices whose dimensions are at least the RLWE ring degree. The concrete efficiency is supported by experiments. The disclosures also provide a variant of the CCMM algorithm with a small size of keys and comparable efficiency.

The present disclosure's CCMM algorithm consists of reducing CCMM to four modular PPMMs, where PPMMs have the same dimension as the given CCMM. From the reduction, the disclosures take full advantage of the high efficiency of existing PPMM libraries (BLAS libraries). The present disclosure's strategy is related with prior reductions from PCMM to PPMM introduced in [4]. This prior work significantly improved the efficiency of PCMM, but the disclosures note that the reduction from CCMM to PPMM has remained an open question. While a pre-FHE scheme provides a hint, it supports only a single CCMM, making further multiplications difficult. In this work, the disclosures present a reduction from CCMM in FHE settings to PPMM and demonstrate its effectiveness in accelerating CCMM.

As a main tool for the present disclosure's CCMM algorithm, the disclosures propose a fast ciphertext matrix transpose (CMT) algorithm. The disclosures devise a new CMT algorithm with a divide-and-conquer approach. The present disclosure's algorithm uses \TILDE Õ(N²) bit operations. The disclosures note that CMT is independent of CCMM and has broader applications. For example, during PPML scenarios, one often needs to convert the client-wise encrypted ciphertexts into feature-wise encrypted ciphertexts and vice versa. The present disclosure's CMT algorithm enables this conversion efficiently.

In addition, the disclosures provide lightweight variants of CCMM and CMT algorithms, which use fewer evaluation keys with comparable efficiency to the prior algorithms. These lightweight algorithms address the large key size of the present disclosure's CCMM and CMT algorithms. For instance, for the CCMM algorithm, the lightweight modification reduces the key size from 1 960 MB to 1.57 MB.

The disclosures implemented the present disclosure's algorithms in the HEaaN library [25]. The present disclosure's implementation takes 85.2 seconds to multiply two 4096*4096 encrypted matrices using CKKS ciphertext of degree 212 in a single thread. For the ciphertext matrix transpose, it takes 0.76 seconds for a square matrix of dimension 2 048. For lightweight CCMM, the present disclosure's implementation uses 1.57 MB of keys, and for lightweight CMT, it uses 0.246 MB, taking 672 seconds for square matrices of dimension 8 192 and 4.92 seconds for a square matrix of dimension 4096, respectively. Although the disclosures focus on the CKKS scheme, the disclosures note that the present disclosure's algorithms are also applicable to BGV and FV schemes.

### 1.2 Technical Overview

The disclosures construct a reduction from CCMM to PPMM, which enables performing CCMM by taking full advantage of highly optimized BLAS libraries such as OpenBLAS [1], LAPACK [3], and FLINT [41]. This strategy improves the practical latency significantly. It is related with [4], which reduces PCMM to PPMM, achieving a significant speed up for PCMM.

In this overview, the disclosures first explain the present disclosure's new CMT algorithm. Then, the disclosures introduce the matrix form of encryptions, which represents RLWE-based ciphertexts encrypting either the rows or the columns of a matrix. Using the representation and CMT algorithm, the disclosures describe the present disclosure's reduction from CCMM to PCMM and introduce the present disclosure's fast CCMM algorithm. Finally, the disclosures explain the lightweight variants of the present disclosure's algorithms to reduce the key size.

Referring to ciphertext matrix transpose, before constructing the reduction from CCMM to PPMM, the disclosures introduce the main tool, the ciphertext matrix transpose (CMT). CMT takes as input ciphertexts encrypting a matrix row-by-row (resp. column-by-column), and returns ciphertexts encrypting the same matrix column-by-column (resp. row-by-row). In this work, the disclosures focus on large matrices where each ciphertext encrypts only one row (resp. column). While the disclosures extensively utilize it for CCMM, the disclosures also note that CMT is an interesting problem beyond its application as a tool for CCMM.

The disclosures start from the well-known observation on ring [symbol] = [symbol] X┐/(X^{N}+1). According to this observation,

$$N \cdot {m}_{j} = {\sum }_{σ ∈ Gal ( ℛ / ℤ )} σ ( {X}^{- j} \cdot m ) .$$

Here, each j=0, 1, . . . , N−1, where

$$m ( X ) = {\sum }_{i = 0}^{N - 1} {m}_{i} {X}^{i}$$

is an element in [symbol] , and

Gal( [symbol] / [symbol] ) is the group of the automorphisms of [symbol] induced by Galois the automorphisms in [symbol] ┌X┐/(X^{N}+1) that fixes [symbol] .

Given N plaintexts {mᵢ=ΣᵢM_{i,j}X^{j}}_{0≤i<N} in [symbol] , where each plaintext stores one row of an N×N matrix M, the plaintexts

$${\{ {m}_{i}^{′} \}}_{0 \leq j < N}$$

that store a transpose matrix Mt are as follows:

$$\begin{matrix}{m}_{j}^{′} = {\sum }_{i = 0}^{N - 1} {M}_{i , j} {X}^{i} = {\sum }_{i = 0}^{N - 1} ( {N}^{- 1} \cdot {\sum }_{σ ∈ Gal ( ℛ / ℤ )} σ ( {X}^{- j} \cdot {m}_{i} ) ) \cdot {X}^{i} \\ = {N}^{- 1} \cdot {\sum }_{σ ∈ Gal ( ℛ / ℤ )} σ ( {\sum }_{i = 0}^{N - 1} {m}_{i} \cdot {σ}^{- 1} ( {X}^{i} ) ) σ ( {X}^{- j} ) . \\ \end{matrix}$$

Here, j=0,1, . . . N−1. The purpose of CMT is to obtain

$${\{ {m}_{j}^{′} \}}_{0 \leq j < N}$$

from {mᵢ}_{0≤i<N} in the encrypted state.

The disclosures proceed in three steps:
computing {\tilde{m}₀=Σᵢmᵢ·σ⁻¹(Xⁱ)}_{σ∈Gal(R/Z)} from {mᵢ}_{0≤i<N},
computing {m̅_{σ}=σ(\tilde{m}_{σ})}σ∈Galt( [symbol] / [symbol] ) using the automorphisms, and
computing

$${\{ {m}_{j}^{′} = {\sum }_{σ} \text{?} \cdot σ ( {X}^{- j} ) \}}_{0 \leq j < N}$$

$$\text{?} \text{indicates text missing or illegible when filed}$$

from {|m_{σ}}_{σ∈Gal(} [symbol] _{/} [symbol] ₎.

The disclosures compute the second step in the encrypted state using N key-switching operations, which involves Ô(N²) bit operations. In Steps 1 and 3, the disclosures devise a fast divide-and-conquer algorithm to reduce the cost to O(N² log N). To summarize, the total cost of the present disclosure's CMT algorithm is Ö(N²) See Section 3 for more details.

Matrix form of encryptions. The disclosures start with a matrix form of the RLWE-based ciphertext, which is also introduced in [4]. The N RLWE-based ciphertexts (aᵢ,bᵢ)_{0<i<N} encrypt each row of a matrix M only under the following condition for

$${ℛ}_{Q} = {ℤ}_{Q} [ X ] / ( {X}^{N} + 1 ) .$$

$$∀ i , {a}_{i} \cdot sk + {b}_{i} \approx {\sum }_{j} {M}_{i , j} {X}^{j} ,$$

where sk is the shared secret key. As described in [4], the disclosures may rewrite the above equation in matrix form:

$$A \cdot Toep ( sk ) + B \approx M , \qquad ( 1 )$$

where each row of A (resp. B) corresponds to a part (resp, b part) of each ciphertext, and where Toep(sk) is the Toeplitz matrix of sₖ=ΣᵢsᵢXⁱ∈ [symbol] .

$$Toep ( sk ) = [ \begin{matrix}{s}_{0} & {s}_{1} & … & {s}_{N - 1} \\ - {s}_{N - 1} & {s}_{0} & … & {s}_{N - 2} \\ … & … & ⋱ & … \\ - {s}_{1} & - {s}_{2} & … & {s}_{0}\end{matrix} ] .$$

The disclosures note that each ciphertext encrypts a row of M. The disclosures call Equation (1) as the matrix form of row-wise encryptions.

In the same way, the disclosures define a matrix form of column-wise encryptions, (aⱼ,bⱼ)_{0≤j<N} encrypting each column of the matrix M, as follows:

$$Toep ( ) \cdot \underline{A} + \underline{B} \approx M ,$$

where each column of A (resp. B) corresponds to the a part (resp, b part) of each ciphertext, and sk is sk(X−1) in R.

Ciphertext-ciphertext matrix multiplication. The disclosures finally explain the reduction from CCMM to PPMMs. The basic idea is to multiply two RLWE-based encryptions in matrix forms (Equation (1)) while preserving the Toeplitz-related structure using CMT. Assume that the disclosures are given two bundles of ciphertexts that encrypt each row of matrices M and M′, respectively. In matrix form, the disclosures are given matrices A, B, A′ and B′ such that in modulo q:

$$A \cdot Toep ( sk ) + B \approx M and {A}^{′} \cdot Toep ( sk ) + {B}^{′} \approx {M}^{′}$$

Using C-MT algorithm, the disclosures transpose the row-wise encryption (A, B) of M. In matrix form, the CMT algorithm outputs the column-wise encryption (A, B) of M that satisfies:

$$Toep ( \vert ) \cdot A + B \approx M and {A}^{′} \cdot Toep ( sk ) + {B}^{′} \approx {M}^{′} .$$

The disclosures multiply the above two matrix forms above to obtain:

$$\begin{matrix}{MM}^{′} \approx ( Toep ( ) \cdot A + B ) \cdot ( {A}^{′} \cdot Toep ( sk ) + {B}^{′} ) \\ = Toep ( ) \cdot {C}_{0 , 0} \cdot Toep ( sk ) + Toep ( ) \cdot {C}_{0 , 1} + {C}_{1 , 0} \cdot Toep ( sk ) + {C}_{1 , 1} ,\end{matrix}$$

where C0,0=AA′, C0,1=AB′, C1,0=BA′, and C1,1=BB′. The disclosures note that the Toeplitz matrices are preserved.

The disclosures consider (C_{6,9}, O) as a column-wise encryption of Toep( [symbol] )·C_{0,0}, and apply CMT algorithm thereto. Then, the disclosures obtain a row-wise encryption (D_{θ}, D₁) of Toep( [symbol] ). C_{0,0}. The disclosures rewrite the same in matrix form:

$$Toep ( ) \text{?} \approx {D}_{0} \cdot Toep ( sk ) + \text{?} .$$

$$\text{?} \text{indicates text missing or illegible when filed}$$

Similarly, by applying CMT to (C_{0,1}, O) the disclosures obtain (D2, D3) such that.

$$Toep ( ) \cdot {C}_{0 , 1} \approx {D}_{2} \cdot Toep ( sk ) + {D}_{3}$$

Putting the results together, the disclosures obtain:

$${MM}^{′} \approx {D}_{0} \cdot Toep ( {sk}^{2} ) + ( {D}_{1} + {D}_{2} + {C}_{1 , 0} ) \cdot Toep ( sk ) + ( {D}_{3} + \text{?} ) .$$

$$\text{?} \text{indicates text missing or illegible when filed}$$

After the row-wise relinearization, which is key switching from sk2 to sk, the disclosures finally obtain a matrix equation:

$${A}^{″} Toep ( sk ) + {B}^{″} \approx {MM}^{′} .$$

This is a matrix form of row-wise encryption of the product matrix MM′. This completes CCMM.

The above protocol reduces CCMM to four PPMMs and three CMTs. The cost of PPMM is O(N^{ω}) where ω is a constant set to 3 in most practical implementations and is at least 2 in theory. Meanwhile, the cost of CMT is Õ(N²), and it is asymptotically negligible compared to PPMMs.

Lightweight algorithms with small key sizes. There is a potential concern about the large key size of the present disclosure's CCMM and CMT algorithms. The previous CMT algorithm requires N evaluation keys for each of the N homomorphic automorphisms. It turns out to be evaluation keys of size \tilde{Ω}(N²) which might be problematic as N is usually large.

To this end, the disclosures suggest a lightweight CMT algorithm that uses only three evaluation keys. The basic idea is to repeatedly update and use a single evaluation key for all homomorphic automorphisms. The disclosures need one evaluation key for all homomorphic automorphisms and two other keys to “update” the evaluation key. This idea is motivated by the hierarchical key management system in [30]. While the update procedure requires additional computation, the asymptotic complexity is the same as the original algorithm.

The disclosures also introduce a lightweight CCMM algorithm. The algorithm follows directly from the lightweight CMT algorithm, requiring 4 evaluation keys, 3 of which are for the CMT algorithm and 1 for relinearization.

### 1.3 Related Works

Comparison to [28]. The seminal work presents a CCMM algorithm adopted by most of the current implementations of CCMM, often with modest modifications [26, 33, 45, 27, 19]. However, it does not reduce CCMM to PPMM, and cannot adopt highly optimized BLAS libraries. As a consequence, although [28] achieves an appropriate bit complexity, its practical performance is several orders of magnitude slower than PPMM. While it performs reasonably well for small matrices, it becomes impractical as the matrix size increases. On the other hand, the disclosures reduce CCMM to PPMM, fully leveraging the high efficiency of BLAS libraries, resulting in a significant speedup.

The disclosures note that [28] focuses on relatively small matrices, and the present disclosure's algorithms are derived for large matrices. As recent machine learning models are becoming larger, scalable CCMM is desirable, particularly in PPML applications based on FHE. The present disclosure's CCMM algorithm is particularly beneficial for PPML on large models.

Other approaches of CCMM. Several other works on CCMM algorithms exist, including [44, 11]. However, previous works do not reduce CCMM to PPMM, resulting in significantly slower performance in practical implementations. In contrast, the present disclosure's CCMM algorithm is compatible with conventional FHE settings and fully benefits from the highly optimized BLAS libraries.

In [44], the authors introduce a CCMM algorithm based on cyclotomic fields of composite order, defined as the product of three pairwise coprime integers. However, the constraint on the choice of cyclotomic fields restricts the FHE parameters, particularly the ciphertext space, and is generally incompatible with conventional FHE parameters.

Another work, [11], proposes using bicyclic encoding for CCMM between coprime-dimensional matrices. However, this algorithm has the drawback of being restricted to specific matrix shapes and generates slots filled by unusable data after CCMM. Consequently. computationally expensive preprocessing or postprocessing steps may be required to continue further computations.

BGN-type cryptosystem [20] is a pre-FHE scheme that supports only a single matrix-matrix multiplication. Its multiplication procedure is similar to ours, except that the disclosures leverage Toeplitz matrices as the disclosures rely on the RLWE problem. For iterative multiplications, GHV-type multiplication faces a fundamental challenge, as its ciphertext structure changes after each multiplication. The disclosures address this issue using the present disclosure's new CMT algorithm. With a well-designed use of CMT, the disclosures propose CCMM algorithms with a consistent input and output format. The present disclosure's CCMM algorithm may be used iteratively without being restricted to quadratic functions, unlike [20].

### 2 Preliminary

Vectors are denoted in bold and lower-case letters, and matrices are indicated with bold and upper-case letters. Vectors are column vectors unless explicitly stated. [n] denotes the set {0,1, . . . n−1} for each positive integer n. For a power-of-two integer N and Q>2, the ring [symbol] is [symbol] [X]/(X^{N}+1) and the ring [symbol] _{Q} is [symbol] /Q [symbol] . Through this invention, N refers to the ring degree of underlying ring [symbol] or [symbol] _{Q}. The disclosures denote a(X)∈ [symbol] as a, omitting the symbol X unless necessary.

The Toeplitz matrix Toep(m) is

$$Toep ( m ) = [ \begin{matrix}{m}_{0} & {m}_{1} & … & {m}_{N - 1} \\ - {m}_{N - 1} & {m}_{0} & … & {m}_{N - 2} \\ ⋮ & ⋮ & ⋱ & ⋮ \\ - {m}_{1} & - {m}_{2} & … & {m}_{0}\end{matrix} ] ,$$

where each ring element

$$m = {\sum }_{i} {m}_{i} {X}^{i} .$$

### 2.1 Ring Operations and Toeplitz Matrix

Let

$$c ( X ) = {\sum }_{k = 0}^{N - 1} {c}_{k} {X}^{k}$$

be the product of two ring elements

$$a ( X ) = {\sum }_{i = 0}^{N - 1} {a}_{i} {X}^{i} and b ( \text{?} ) = {\sum }_{j = 0}^{N - 1} \text{?} {X}^{i}$$

$$\text{?} \text{indicates text missing or illegible when filed}$$

### in R. Concretely,

$${c}_{k} = {\sum }_{i = 0}^{N - 1} ( {\sum }_{j = 0}^{k} {a}_{i} {b}_{k - j} - {\sum }_{j = k + 1}^{N - 1} {a}_{i} {b}_{k - j + N} ) , \qquad ( 2 )$$

where k∈[N], and X^{N}=−1 in R. Using this equation, by checking each entry, the disclosures may verify that the relation c(X)=a(X)×b(X) in R is equivalent to the following matrix equation:

$$[ \begin{matrix}{a}_{0} & {a}_{1} & … & {a}_{N - 1}\end{matrix} ] Toep ( b ) = [ \begin{matrix}{c}_{0} & {c}_{1} & … & {c}_{N - 1}\end{matrix} ] ,$$

where Toep(b) is as defined above. In addition, by stacking the matrix equations vertically, the disclosures may verify that the relation {cᵢ(X)=aᵢ(X)·b(X)}_{i∈{n} equivalent to

$$[ \begin{matrix}{a}_{0}^{t} \\ {a}_{1}^{t} \\ ⋮ \\ {a}_{n - 1}^{t}\end{matrix} ] Toep ( b ) = [ \begin{matrix}{c}_{0}^{t} \\ {c}_{1}^{t} \\ ⋮ \\ {c}_{n - 1}^{t}\end{matrix} ] , \qquad ( 3 )$$

where the vector aᵢ(resp. Cᵢ) consists of the coefficients of aᵢ(X) (resp. cᵢ(X)) for each i∈[n]. Each relation aᵢ(X)·b(X)=cᵢ(X) is related to each i-th row of Equation (3).

There is another direction to bridge the ring multiplication with the Toeplitz matrix. From using Equation (2), the disclosures check each entry to verify that the relation c(X)=a(X)·b(X) in ring R is equivalent to

$$Toep ( \tilde{a} ) [ \begin{matrix}{b}_{0} \\ {b}_{1} \\ ⋮ \\ {b}_{N - 1}\end{matrix} ] = [ \begin{matrix}{c}_{0} \\ {c}_{1} \\ ⋮ \\ {c}_{N - 1}\end{matrix} ] ,$$

where ã(X)∈ [symbol] is

$$a ( {X}^{2 N - 1} ) = a \text{?} - \text{?} {a}_{N - i} {X}^{i} .$$

$$\text{?} \text{indicates text missing or illegible when filed}$$

By stacking the above equations horizontally, the disclosures may verify that the relation {cⱼ(X)=a(X)·bⱼ(X)}₃ is equivalent to

$$Toep ( \tilde{a} ) [ \begin{matrix}{b}_{0} & {b}_{1} & … & {b}_{n - 1} ] =\end{matrix} [ \begin{matrix}{c}_{0} & {c}_{1} & … & {c}_{n - 1} ] ,\end{matrix} \qquad ( 4 )$$

where the vector bⱼ(resp. cⱼ) consists of the coefficients of bⱼ(x) (resp. cⱼ(X)) for each j∈[n]. The disclosures note that each relation a(X)·bᵢ(X)=cᵢ(X) is related to each j-th column of Equation (4).

All the above discussions may be generalized to RQ by applying the same arguments in modulo Q.

### 2.2 Ring Automorphisms and Trace

The ring R is the extension ring of [symbol] . The disclosures introduce the Galois group Gal( [symbol] / [symbol] ), which is a group of automorphisms of R induced by Galois automorphisms [symbol] [X]/(X+1) that fix [symbol] . In particular,

$$σ ( {r}_{1} + {r}_{2} ) = σ ( {r}_{1} ) + σ ( {r}_{2} ) , σ ( {r}_{1} {r}_{2} ) = σ ( {r}_{1} ) σ ( {r}_{2} ) , σ ( n ) = n$$

for all σ∈Gal( [symbol] / [symbol] ), r₁, r₂ ∈ [symbol] , and n∈

[symbol]

For the ring [symbol] =/ [symbol] └X┘/(X^{N}+1), it is known that Gal( [symbol] / [symbol] )={σₜ: X [symbol] X²⁺¹|t∈[N]}, and is generated by two generators, X [symbol] X^{s} and x [symbol] x⁻¹.

The trace of a ring element T∈ [symbol] is

$$Tr ( r ) {\sum }_{σ ∈ Gal ( ℛ / ℤ )} σ ( r ) .$$

If the disclosures represent the ring element r as a polynomial ΣᵢrᵢXⁱ, then it is known that

$$Tr ( r ) = N \cdot {r}_{0} .$$

Following the above discussion in modulo Q, all the above discussion may be extended to RQ.

### 2.3 HOMOMORPHIC ENCRYPTION AND THE CKKS SCHEME

Among various existing HE schemes [12, 8, 7, 18, 15, 17], the disclosures mainly focus on the CKKS scheme. The CKKS [12] HE scheme supports arithmetic over real numbers. It relies on the ring-learning-with error (RLWE) problem [39, 32] over the ring [symbol] = [symbol] [X]/(X^{N}+1). The present disclosure's algorithm is applicable to other existing RLWE-based schemes, such as BGV [8] and FV [7, 18] schemes. The RLWE-based HE schemes have structures similar to those of the CKKS scheme except for the encoding structure.

Encoding, decoding, encryption, and decryption. Conventionally, the CKKS uses the slot encoding. The slot encoding and slot decoding are maps between a message space [symbol] and a plaintext space [symbol] . To decode a plaintext m(X)∈ [symbol] , the disclosures first embed m(X) into [symbol] [X]/(X^{N}+1), and the decoded message is

$${\{ \frac{1}{Δ} m ( {ζ}_{j} ) \}}_{j ∈ [ N / 2 ]} ,$$

where Δ is the scale factor and

$${ζ}_{j} = {e}^{2 i {π5}^{j} / 2 N}$$

for each j∈[N/2]. The encoding is the inverse of the decoding. The slot-encoding supports slot-wise operations having a single instruction, multiple data (SIMD) property. For most of the homomorphic computations, the slot-encoding is desirable.

Another encoding type is the coefficient encoding. The coefficient encoding and coefficient decoding are maps between [symbol] and the plaintext space [symbol] . The coefficient encoding of real vectors {m₀, . . . , m_{N-1}} having the scale factor Δ is a ring element

$$[ Δ ( {\sum }_{i = 0}^{N - 1} {m}_{i} {X}^{i} ) ] .$$

In general, the coefficient encoding is not appropriate for the homomorphic multiplication because the coefficient encoding is incompatible with ring multiplication. Nevertheless, coefficient encoding is used for several FHE algorithms, such as ring packing [5, 34, 10], bootstrapping [13], and PCMM [4]. The present disclosure's CCMM algorithm also operates in the coefficient encoding.

A CKKS ciphertext of an encoded message m∈ [symbol] encrypted using a secret key sk∈ [symbol] is a pair of ring elements

$$( a , b ) ∈ {ℛ}_{Q}^{2}$$

satisfying α·sk+b=m+e in RQ, where e is a small error from RQ. To decrypt a CKKS ciphertext (a, b), the disclosures decode the ring element ask+b, where sk is the secret key. The secret key sk is typically a sparse ternary ring element in R. The coefficients are from {−1, 0, 1}, and only hwt coefficients are non-zero among N coefficients.

Homomorphic operations. The CKKS scheme supports the following homomorphic operations. The operations below are compatible with both the coefficient encoding and the slot encoding.

Add. For given ciphertexts ct₀, ct₁ ∈ [symbol] encrypting m₀, m₁∈ [symbol] , respectively, it returns a ciphertext ct_{Add} that encrypts m₀+m₁.

Rescale. For a given ciphertext cₜ ∈ [symbol] ², encrypting m∈ [symbol] , it returns ct′∈ [symbol] encrypting └Q₀m/Q₁┘.

By selecting Q₁/Q₀≈Δ, a Rescale procedure may manage scaled errors and scale factors after PtMult and Mult operations.

PtMult. For a given ciphertext ct∈ [symbol] encrypting m, and a plaintext μ∈ [symbol] , it returns a ciphertext ct_{PtMult} that encrypts μm.

For reference, the error inside ct is also multiplied by μ, which may be managed by the Rescale procedure. In addition, the scale factor of ct_{PuMult} is a product of the scale factors of m and μ, which may also be managed by the Rescale procedure.

KeySwitch. For a given ciphertext ct∈ [symbol] encrypted using the secret key sk, it returns a ciphertext ct∈ [symbol] encrypted using sk′.

The KeySwitch procedure requires a switching key from sk to sk′ which belongs to

$${R}_{PQ}^{2} ,$$

where p is an auxiliary modulus for the key switching.

The auxiliary modulus and gadget decomposition are used to manage an error during KeySwitch. A rank of the gadget decomposition is referred to as dnum (see [23] for details).

Mult. For given ciphertexts ct₀, ct₁∈ [symbol] encrypting m₀, m₁∈ [symbol] . respectively, it returns a ciphertext ct_{Mult} that encrypts m₀m₁.

It requires a relinearization key, a switching key from sk to sk2. Similar to PtMult, both the error and the scale factor increase, which may be managed by a Rescale procedure.

In case of the slot encoding, it provides slot-wise multiplication over complex numbers.

Auto. For a given ciphertext cte∈ [symbol] encrypting m∈ [symbol] , it returns a ciphertext ct_{c} that encrypts σ(m).

If σ(X)=X^{2j+1} is an automorphism in σ∈Gal( [symbol] / [symbol] ) the disclosures denote ct_{σ}, which is the output of homomorphic automorphism performed on the ciphertext ct, as
Auto(ct:2j+1).

The homomorphic automorphism requires an automorphism key, a switching key from σ(sk) to sk.

For slot encoding ciphertexts, the CKKS algorithm provides more native operations by using the homomorphic structure of the slot encoding.

Rotate. For a given ciphertext ct_{Q}∈ [symbol] encrypting complex vector (m₀ . . . , m_{N/2-1}) and an integer n, it returns a new ciphertext ct′∈ [symbol] encrypting {mᵣ, mᵣ₊₁ . . . , m_{N/2-1}, m₀, . . . , mᵣ₋₁}.

It requires an automorphism key for X [symbol] X⁻¹.

Conj. For the given ciphertext ct∈ [symbol] encrypting the complex vector (m₀ . . . , m_{N/2-1}) and the integer n, it returns a ciphertext encrypting ct′∈ [symbol] that encrypts the conjugate vector {m̅₀, . . . , m̅_{N/2-1}}.

It requires an automorphism key for X [symbol] X⁻¹.

The disclosures remark that the operations related to KeySwitch (i.e., Mult, Auto, Rotate, Conj) require O(N log N) operations in ZQ.

Modulus and bootstrapping. The disclosures remark that PtMult and Mult require Rescale to manage the scale factor and error, and the Rescale procedure consumes the modulus of the ciphertext space. Once the modulus becomes too low, the disclosures should refresh the modulus by using bootstrapping procedure in order to use CKKS as a fully FHE scheme.

However, bootstrapping is much heavier than the other homomorphic operations. In practical applications, the number of bootstrapping significantly affects the timing. Consequently, it is desirable to devise homomorphic algorithms that consume less moduli (i.e., have smaller multiplicative depth).

The current CKKS bootstrapping algorithms generally follow either of two approaches: S2C-first bootstrapping and C2S-first bootstrapping. For most applications, S2C-first bootstrapping is faster. The disclosures remark that during S2C-first bootstrapping, the ciphertexts use coefficient-encoding at the lowest modulus. The disclosures note that the present disclosure's algorithms operate in coefficient-encoding, allowing us to use the smallest parameters during FHE computation while leveraging the fast S2C-first bootstrapping.

Most practical CKKS implementation adopts RNS (residual number system) CKKS [6, 14]. For the sake of simplicity, in the RNS system, the disclosures consider modulus level, which indicates the remaining number of times the disclosures may rescale it. For example, the fresh ciphertext would have a modulus level of 12, and each multiplication consumes one modulus level. Once the level becomes too low, the disclosures perform bootstrapping to recover the modulus level back to 12.

### 3. Ciphertext Matrix Transpose

The disclosures propose a fast ciphertext matrix transposition (CMT) algorithm. The present disclosure's algorithm converts N ciphertexts that encrypt each row of a given matrix to N ciphertexts that encrypt each column. To be precise, for a given N×N matrix M, the that present disclosure's CMT algorithm takes as inputs N ciphertexts (aᵢ, bᵢ)_{i∈[N]}

$${a}_{i} \cdot sk + {b}_{i} \approx {\sum }_{j} {M}_{i , j} {X}^{j}$$

for all i∈[N], and returns N ciphertexts

$${( {a}_{j}^{′} , {b}_{j}^{′} )}_{j ∈ [ N ]}$$

such that

$${a}_{j}^{′} \cdot sk + {b}_{j}^{′} \approx {\sum }_{i} {M}_{i , j} {X}^{i}$$

for all j∈[N], where sk is the secret key. While the present disclosure's algorithm focuses on N×N matrices, it may be extended to larger matrices by transposing each N×N submatrix blocks individually.

Before delving into details, the disclosures introduce an interesting application of CMT. Consider FHE scenarios with multiple parties, such as multi-party HE [35] and proxy re-encryption [22]. Each client party encrypts its data with multiple features in the ciphertext, sends the ciphertext(s) to the computing server, and the server computes tasks over the aggregated ciphertexts. During the computation, the server often needs to convert the client-wise encrypted ciphertexts into feature-wise encrypted ciphertexts and vice versa. This problem is the same problem with CMT, and the disclosures may directly apply the CMT algorithm to these scenarios. FIG. 11 illustrates how to use CMT algorithms for the multi-party settings.

FIG. 11 illustrates a visualization of the application of the CMT. Another CMT may convert the feature-wise encryptions to client-wise encryptions before sending the results back to each client.

In this section, the disclosures propose a CMT algorithm with Õ(N²) operations in ZQ. The disclosures note that a transpose requires at least Ω(N²) operations to read and write the data. Also, the disclosures point out that the present disclosure's algorithm does not consume any modulus. Furthermore, the disclosures transpose the data in coefficients-encoding ciphertexts, enabling us to perform it at the lowest modulus with the fastest bootstrapping algorithms.

The proposed transpose algorithm may be generalized for other formats, such as MLWE [29, 8] and shared-a RLWE [37, 4, 21, 9], to transpose encrypted data in those formats for matrices of various dimensions. However, while the transpose for RLWE format is useful for CCMM as the disclosures will describe in Section 4, transposes for other formats might not be directly useful for efficient CCMM.

### High-Level Description

The disclosures first describe the motivation of the present disclosure's algorithm with clear ring elements. The present disclosure's algorithm starts from the observation that the trace of a ring element m(X)=ΣᵢmᵢXⁱ∈ [symbol] is the constant term m0 of ring elements. Formally,

$$N \cdot {m}_{0} = Tr ( m ( X ) ) = {\sum }_{i = 0}^{N - 1} m ( {{X}^{2}}^{+ 1} ) .$$

Similarly, for each j∈[N], if the disclosures take the trace of X^{-j}·m(X), the disclosures obtain mⱼ. Here,

$$N \cdot {m}_{j} = Tr ( {X}^{- j} \cdot m ( X ) ) = {\sum }_{t = 0}^{N - 1} {X}^{- j ( 2 t + 1 )} \cdot m ( {X}^{2 t + 1} ) .$$

To utilize the result for CMT, assume that the disclosures are given N ring elements m₀, . . . , m_{N-1} in RQ as follows:

$${m}_{i} ( X ) = {\sum }_{j} {m}_{i , j} {X}^{j} ∈ {ℛ}_{Q} .$$

In CMT, the disclosures aim to obtain

$${m}_{j}^{′}$$

satisfying

$${m}_{j}^{′} ( X ) = {\sum }_{i} {m}_{i , j} {X}^{i} ∈ {ℛ}_{Q} ,$$

for each j∈[N], The previous observation implies that

$$\begin{matrix}N \cdot {m}_{j}^{′} ( X ) = {\sum }_{i} Tr ( {X}^{- j} \cdot {m}_{i} ) \cdot {X}^{i} = {\sum }_{i} {\sum }_{t} {X}^{- j ( 2 t + 1 ) + i} \cdot {m}_{i} ( {X}^{2 t + 1} ) \\ = {\sum }_{t} ( {\sum }_{i} {X}^{i} \cdot {m}_{i} ( {X}^{2 t + 1} ) ) {X}^{- j ( 2 t + 1 )} ∀ j ∈ [ N ] .\end{matrix}$$

An important point is that the term ΣᵢXⁱ·mᵢ(X^{2t+1}) is independent of j for all t∈[N].

Based on the above discussion, in summary, the present disclosure's proposed CMT algorithm is expressed as follows:

Computing

$${\{ {\tilde{m}}_{i} = {\sum }_{i} {m}_{i} ( X ) \cdot {X}^{i \cdot ( 2 i + 1 ) - x} \}}_{t ∈ [ N ]}$$

(where {mᵢ}_{t∈{N}}),
computing {\tilde{m}ᵢ=\tilde{m}ₜ(X^{2t+1})}_{t∈{N}} (where {\tilde{m}ᵢ}_{t∈{N}}), and
computing

$${\{ {m}_{j}^{′} = {\sum }_{t} {\tilde{m}}_{i} ( X ) \cdot {X}^{- j ( 2 t + 1 )} \}}_{j ∈ \{ N \}}$$

(where {m̅}_{t∈[N]}).

The disclosures may homomorphically compute all the above steps in the encrypted state by using key switching and arithmetic operations of FHE schemes. The homomorphic algorithm includes only N key switchings (the second step), which is desirable. However, it requires N2 ring additions during the first and third steps, which uses O(N²) operations in ZQ.

To this end, the disclosures devise a Tweak algorithm that may compute the first and third steps. This algorithm uses Õ(N²) operations instead of Ω(N³). The observation is that, in the above steps, all ring additions involved are structured and have the following form:

$${\sum }_{i} {m}_{i} \cdot {X}^{2 ij} ∀ j ∈ [ N ] .$$

The present disclosure's Tweak algorithm (Algorithm 1) efficiently computes the structured additions having such a form.

In Section 3.2, the disclosures explain the Tweak algorithm, and in Section 3.3, the disclosures describe the full CMT algorithm.

### 3.2 Tweak Algorithm

The present disclosure's Tweak algorithm takes n ciphertexts {ctᵢ}_{i∈[n]} as input and returns n ciphertexts as follows:

$${\{ {\sum }_{i} {X}^{2 ij \frac{N}{n}} \cdot {ct}_{i} \}}_{j ∈ [ n ]} .$$

The Tweak algorithm computes the above n² ring additions over [symbol] (which usually requires Ω(n²N) additions over [symbol] ), with Õ(nN) additions in [symbol] . While the disclosures utilize it for CMT in this paper, TWEAK algorithm might have many applications related to homomorphic computations with structured circuits. Algorithm 1 describes the algorithm.

Algorithm 1 TWEAK

```
Require: A power-of-two integer n, and n ciphertexts ct.
$Ensure : Ciphertexts {ct}^{′} such that {ct}_{j}^{′} = {\sum }_{i} X \text{?} ct \text{?} for each j ∈ [ n ]$
  1: if n = [symbol]     then
  2: return ct
  3: end if
  4: ct′₀ = ct₀
  5: for [symbol]   ← 0 to log n − 1 do
  6: aux ← TWEAK ( [symbol]  {ct [symbol]  / [symbol] } [symbol]  )
  7: for j ← 0 to [symbol]  − 1 do
  $8 : ct \text{?} ← {ct}_{j} - X \text{?} {aux}_{j}$
  $9 : {ct}_{j}^{′} ← {ct}_{j} - X \text{?} {aux}_{j}$
10: end for
11: end for
$12 : return \{ {ct}_{j}^{′} \} \text{?}$ [symbol]
indicates data missing or illegible when filed
```

The disclosures prove the correctness of the Tweak algorithm in Theorem 1.

Theorem 1. Algorithm 1 is correct.

Proof. The disclosures prove the correctness by using induction on n. If n=1, the correctness is trivial. Then, assume that the algorithm is correct for all integer no less than n, where n>1.

The disclosures claim that

$${ct}_{j}^{′} = \sum \text{?} X \text{?} \cdot ct \text{?}$$

$$\text{?} \text{indicates text missing or illegible when filed}$$

for each j∈[ [symbol] ]. This claim holds after the [symbol] -th iteration of lines 6 to 11. Before entering the loop, the claim trivially holds for [symbol] =−1.

Assume that the claim holds after ( [symbol] −1)-th iteration. By the induction hypothesis,

$$\begin{matrix}{ct}_{j}^{′} = {\sum }_{i ∈ [ 2 \text{?} ]} X \text{?} \cdot ct \text{?} - X \text{?} ( {\sum }_{i ∈ [ {2}^{k} ]} X \text{?} \cdot ct \text{?} ) \\ = {\sum }_{i ∈ [ 2 \text{?} ]} X \text{?} \cdot ct \text{?} - {\sum }_{i ∈ [ 2 \text{?} ]} X \text{?} \cdot ct \text{?} \\ = {\sum }_{i ∈ [ 2 \text{?} ]} X \text{?} \cdot ct \text{?}\end{matrix}$$

$$\text{?} \text{indicates text missing or illegible when filed}$$

for each j∈[ [symbol] ].

In addition, X^{N}=−1 in [symbol] . Accordingly,

$$\begin{matrix}{ct}_{j + {2}^{′}}^{′} = {\sum }_{i ∈ [ 2 \text{?} ]} X \text{?} \cdot ct \text{?} - X \text{?} ( {\sum }_{i ∈ [ 2 \text{?} ]} X \text{?} \cdot ct \text{?} ) \\ = {\sum }_{i ∈ [ 2 \text{?} ]} X \text{?} \cdot ct \text{?} - {\sum }_{i ∈ [ 2 \text{?} ]} X \text{?} \cdot ct \text{?} \\ = {\sum }_{i ∈ [ 2 \text{?} ]} {( - 1 )}^{i} X \text{?} \cdot ct \text{?} = {\sum }_{i ∈ [ 2 \text{?} ]} X \text{?} \cdot ct \text{?} ,\end{matrix} .$$

$$\text{?} \text{indicates text missing or illegible when filed}$$

To summarize, after the [symbol] -th iteration,

$${ct}_{j}^{′} = \sum \text{?} X \text{?} \cdot ct \text{?}$$

$$\text{?} \text{indicates text missing or illegible when filed}$$

for each j∈[ [symbol] ], and the claim holds for all [symbol] s. In particular, after the final iteration, [symbol] becomes log n−1, and

$${ct}_{j}^{′} = {\sum }_{i ∈ [ n ]} X \text{?} \cdot {ct}_{i}$$

$$\text{?} \text{indicates text missing or illegible when filed}$$

for each j∈[n].

This equation indicates that Algorithm 1 is correct for n. By mathematical induction, Algorithm 1 is correct for all power-of-two integers n>1.

The disclosures now describe that the Tweak algorithm may be performed using O(RN) operations in Theorem 2.

Theorem 2. Algorithm 1 uses Õ(nN) operations in ZQ.

Proof. Assume that the cost of the Tweak algorithm on n ciphertexts is T (n). Each [symbol] -th iteration of lines 6 to 11 may be performed using T( [symbol] )+2· [symbol] operations. Therefore,

$$T ( n ) = T ( n / 2 ) + T ( n / 4 ) + … + T ( 1 ) + 4 nN = 2 T ( n / 2 ) + 2 nN ,$$

which implies that T(n)=O(Nn log n)=Õ(nN).

Algorithm 2 TRANSPOSE

```
Require: N ciphertexts ct such that ct [symbol]   encrypts m [symbol]   = {m [symbol]  , ... , m [symbol]  } in its
  coefficient for each i ∈ [N].
$Ensure : N ciphertexts {ct}^{′} such that {ct}_{j}^{′} encrypts {m}_{j}^{′} = \{ m \text{?} , … , m \text{?} \} for each$
  j ∈ [n].
  1: aux ← TWEAK (N, {Xⁱ · ct [symbol]  } [symbol] )
  2: for j ← 0 to N − 1 do
  $3 : aux \text{?} ← ( N \text{?} mod Q ) \cdot aux \text{?}$
  $4 : aux \text{?} ← Auto ( {aux}_{j}^{′} : 2 j + 1 )$
  5: end for
  6: ct″ ← TWEAK (N, aux′)
  7: for j ← 1 to N do
  $8 : ct \text{?} ← - {X}^{N} \text{?} \cdot ct \text{?}$
  9: end for
10: return ct′ [symbol]
indicates data missing or illegible when filed
```

### 3.3 CMT Algorithm

The disclosures propose a CMT algorithm using Õ(N²) operations in ZQ, by applying the Tweak algorithm to the present disclosure's approach in Section 3.1.

The disclosures describe the full algorithm in Algorithm 2. In summary, the given input ciphertexts ct are adjusted to obtain aux, and aux is then adjusted again to obtain the transposed ciphertexts ct′.

Algorithm 2 does not consume moduli during computation. A constant N⁻¹ mod Q multiplied before key switching. The algorithm involves a trace operation over RQ, thus multiplying by N⁻¹ mod Q before key switching eliminates error growth during the process. It is noted that, for FHE schemes (especially in case of using RNS-based HE schemes), it is customary to select N as a power-of-two integer and Q as a product of primes congruent to 1 modulo 2N. This technique is already used in [10].

The disclosures now prove the correctness of a Transpose algorithm in Theorem 3.

Theorem 3. Algorithm 2 is correct.

Proof. From the correctness of Algorithm 1, after line 1,

$${aux}_{t} = {\sum }_{i} {X}^{2 it} \cdot ( {X}^{i} \cdot {ct}_{i} ) = {\sum }_{i} {X}^{i ( 2 t + 1 )} \cdot {ct}_{i}$$

for each t∈[N].

After rearrangement and key switching (lines 2 to 5),

$$N \cdot {aux}_{t}^{′} = Auto ( {\sum }_{i} {X}^{i {( 2 t + 1 )}^{- 1}} \cdot {ct}_{i} ; 2 t + 1 ) = {\sum }_{i} {X}^{i} \cdot {ct}_{i} ( {X}^{2 t + 1} )$$

for each t∈[N].

Again by Theorem 1, after the Tweak algorithm in line 6, ct″ satisfies i∈[N].

$$N \cdot {ct}_{j}^{″} = N \cdot {\sum }_{t} ( {X}^{2 jt} \cdot {aux}_{t}^{′} ) = {\sum }_{t} {\sum }_{i} {X}^{2 jt} \cdot {X}^{i} \cdot {ct}_{i} ( {X}^{2 t + 1} ) .$$

Finally, for each j∈[N]

$$\begin{matrix}N \cdot {ct}_{( N - j ) modN}^{′} = - {X}^{j} \cdot {\sum }_{t} \text{?} {X}^{2 jt} \cdot {X}^{i} \cdot {ct}_{i} ( {X}^{2 i + 1} ) \\ = - {\sum }_{t , i} {X}^{j ( 2 t + 1 )} \cdot {X}^{i} \cdot {ct}_{i} ( {X}^{2 t + 1} ) = - {\sum }_{i} {X}^{i} \cdot Tr ( {X}^{j} \cdot {ct}_{i} ) \\ = - {\sum }_{i} X \text{?} \cdot Tr ( Enc ( \{ - {m}_{i , N - j} , … , {m}_{i , N - j - 1} \} ) ) \\ = N \cdot Enc ( {\sum }_{i} {m}_{i , N - j} \cdot X \text{?} )\end{matrix}$$

$$\text{?} \text{indicates text missing or illegible when filed}$$

Therefore, Algorithm 2 is correct.

The disclosures finally show that the present disclosure's CMT algorithm (Algorithm 2) costs Õ(N²) operations.

Theorem 4. Algorithm 2 uses Õ(N²) operations in ZQ.

Proof. Algorithm 2 consists of two Tweak and N key switching. The cost of each Tweak is Õ(N²) by Theorem 2, and the cost of each key switching is Õ(N²). Consequently, the overall cost of Algorithm 2 is Õ(N²).

Asymptotically, the present disclosure's CMT algorithm is almost optimal. The disclosures stress that as the disclosures manipulate N2 messages, the lower bound of the cost of CMT is Ω(N²). In addition, the present disclosure's algorithm does not consume moduli.

### 4 Ciphertext-ciphertext Matrix Multiplication

In this section, the disclosures propose a new algorithm for homomorphic matrix multiplication. The present disclosure's algorithm focuses on large matrices whose dimension is larger or equal to the RLWE ring dimension N. For ease of discussion, the disclosures focus on the square matrices of size N×N. Extending the present disclosure's algorithm to larger matrices is easy.

One of the difficulties of CCMM involves homomorphic computation with a mathematical structure. Even though there exist several works including [28], which are asymptotically optimal, the overhead from homomorphic computation, e.g., inefficient memory access, makes it hardly practical for large matrices. While PPMM is a well-studied problem and there exist PPMM libraries with low-level optimizations, CCMM needs to be more scalable.

To this end, the disclosures reduce CCMM to PPMM. This reduction enables us to utilize highly optimized linear algebra libraries for ciphertext matrix multiplications, significantly improving the timing. This reduction-based approach is related with [4] and also references [31], both of which construct and utilize reductions from PCMM to PPMM.

### 4.1 Matrix Form of RLTHE Disclosures Ciphertexts

The disclosures introduce the matrix form from [4] and use the same to construct the reduction from CCMM to PPMM. To manipulate matrices whose dimension is equal to N, the disclosures use N RLWE ciphertexts. For example, each row of an N×N matrix M may be encrypted into N ciphertexts ct. Here, ctᵢ=(aᵢ, bᵢ) and bᵢ=aᵢ, sk+mᵢ in RQ. In particular, mᵢ=└Δ(ΣⱼM_{i,j}X^{j})+e(X)┘, which corresponds to the coefficient encoding of the i-th row of M. This configuration is expressed as a matrix equation using Toeplitz matrices based on Equation (3) as follows:

$$A \cdot Toep ( sk ) + B \approx M \qquad ( 5 )$$

It is noted that the respective rows of A, B, and M correspond to ai, bi, and mi for each. The disclosures stress that the disclosures may view N RLWE ciphertexts by using i. The disclosures stress that the disclosures may view N RLWE ciphertexts by using Equation (3), and conversely, the disclosures may view Equation (3) as N RLWE ciphertexts, from which each row of A and B may be extracted. For further details, refer to Section 2.1

It is also possible to encrypt each column of M. The following equation using Equation (4) corresponds to the column-wise encryptions [symbol] [symbol] of M.

$$Toep ( ) \cdot \underline{A} + \underline{B} \approx M . \qquad ( 6 )$$

Each column of [symbol] , [symbol] ,and M corresponds to a, b, and m parts of each ciphertext. Here, [symbol] =sk(X⁻¹). For further details, refer to Section 2.1.

In the present disclosure, the row-wise encryption is set as a default format. For N×N matrices A and B, saying that ct=(A, B) encrypts an N×N matrix M indicates that each row of M is encrypted and A*Toep(sk)+B=M. If key switching or rescaling performed on the ciphertext (A, B), the operation is performed on each row. If column-wise encryption is used, this is clarified by using an underbar. For example, encrypting M indicates that each column of M is encrypted and Toep(sk)· [symbol] + [symbol] =M.

CMT in matrix form. Algorithm 3 may be represented in the matrix form (by using Equations (5) and (6)). Algorithm 2 transforms ciphertexts that encrypt each row in their coefficient representation into ciphertexts that encrypt each column in their coefficient representation. In the matrix form, the algorithm is interpreted as a transformation between (A, B) and (A. B), and satisfying:

$$A \cdot Toep ( sk ) + B \approx Toep ( ) \cdot \underline{A} + \underline{B} .$$

### 4.2 CCMM Algorithm

The disclosures propose a new CCMM algorithm. The present disclosure's algorithm takes two row-wise encryptions of matrices as inputs and outputs a row-wise encryption of the product matrix.

Assume that the disclosures are given matrices M and M′ of size N×N, and their row-wise encryptions ct=(A,B) and ct′=(A′, B′). The disclosures may represent the respective encryptions in matrix forms as follows:

$$M \approx A \cdot Toep ( sk ) + B$$

$$and$$

$${M}^{′} \approx {A}^{′} \cdot Toep ( sk ) + {B}^{′} .$$

By using CMT, the row-wise encryption (A,B) is then transposed to obtain the column-wise encryption ( [symbol] , [symbol] ) of M.

$$M \approx Toep ( ) \cdot \underline{A} + \underline{B} .$$

The multiplication of ( [symbol] , [symbol] ) and (A′, B′) is then performed in matrix form.

$${MM}^{′} ( Toep ( ) \cdot \underline{A} + \underline{B} ) \cdot ( {A}^{′} \cdot Toep ( sk ) + {B}^{′} ) = Toep ( ) \cdot \underline{A} {A}^{′} \cdot Toep ( sk ) + Toep ( ) \cdot \underline{A} {B}^{′} + \underline{B} {A}^{′} \cdot Toep ( sk ) + \underline{B} {B}^{′} .$$

Two column-wise encryptions ( [symbol] A′,0) of Toep( [symbol] )· [symbol] A′) and ( [symbol] B′,0) of Toep( [symbol] )· [symbol] B′) are transposed, respectively. Accordingly, two row-wise encryptions (Â,\hat{B}) of Toep( [symbol] )· [symbol] A′) and (Ǎ,B̌) of Toep( [symbol] )· [symbol] B′) are obtained. To be more precise, in matrix form,

$$Toep ( ) \cdot \underline{A} {A}^{′} \approx \hat{A} \cdot Toep ( sk ) + \hat{B} ,$$

$$Toep ( ) \cdot \underline{A} {B}^{′} \approx \check{A} \cdot Toep ( sk ) + \check{B} .$$

To summarize, the result is expressed as follows:

$$\begin{matrix}{MM}^{′} \approx \hat{A} \cdot Toep ( sk ) \cdot Toep ( sk ) + ( \hat{B} + \check{A} + \underline{B} {A}^{′} ) \cdot Toep ( sk ) + ( \check{B} + \underline{B} {B}^{′} ) \\ = \hat{A} \cdot Toep ( {sk}^{2} ) + ( B \text{?} + A \text{?} + \underline{B} {A}^{′} ) \cdot Toep ( sk ) + ( B \text{?} + \underline{B} {B}^{′} )\end{matrix} .$$

$$\text{?} \text{indicates text missing or illegible when filed}$$

As the last step, the disclosures relinearize and rescale each row of (Ǎ, B̌+Ǎ+ [symbol] A′, B+ [symbol] B′) This step outputs the row-wise encryptions of MM′. This completes the CCMM procedure.

To sum up, from the row-wise encryptions of M and M7, the disclosures obtained the row-wise encryptions of the product matrix MM′. Algorithm 3 describes the present disclosure's algorithm in full detail.

The correctness of Algorithm 3 is directly derived from the above discussion and Theorem 3. While Algorithm 3 focuses on N×N matrices, the disclosures may use it for larger matrices by using a block approach [28]: splitting the large matrices into submatrices of size N×N and multiplying two matrices of submatrices. To reduce costs, the disclosures may use the Strassen algorithm for the block approach.

Cost analysis. The present disclosure's algorithm consists of three transpositions (line 1, 3, and 4), N key switching (line 5), N rescaling (line 6), and a PPMM (line 2). The PPMM part is the heaviest, while the disclosures may use highly optimized linear algebra libraries to implement it. The components other than PPMM may be done with Õ(N²).

Algorithm 3 CC-MM

```
Require: N ciphertexts ct^{υ} = (A^{υ}, B^{υ}) encrypting an N × N matrix U;
  A^{υ} Toep(sk) + B^{υ} = U.
Require: N ciphertexts ct^{V} = (A^{V}, B^{V}) encrypting an N × N matrix V;
  A^{V} Toep(sk) + B^{V} = V.
Ensure: N ciphertexts ct^{W} = (A^{W}, B^{W}) encrypting an N × N matrix W;
  A^{W} Toep(sk) + B^{W} = W, where W = UV is the N × N product matrix.
1: ( [symbol] , [symbol] ) ← Transpose(ct^{υ})
$2 : [ \begin{matrix}{\underline{M}}_{00} & {\underline{M}}_{01} \\ {\underline{M}}_{10} & {\underline{M}}_{11}\end{matrix} ] ← [ \begin{matrix}{\underline{A}}^{U} \\ {\underline{B}}^{U}\end{matrix} ] [ \begin{matrix}{A}^{V} & {B}^{V}\end{matrix} ]$
3: (Ă, B̆) ← Transpose((M [symbol]  , 0))
4: (Â, \hat{B}) ← Transpose(M [symbol]  , 0)
5: ( [symbol]  , [symbol]  ) ← KS [symbol]   (Â, 0)) + (\hat{B}, 0)
6: (A^{W}, B^{W}) ← Rescale (Â, \hat{B}) + (Ă, B̆) + (M₁₀), M₁₁))
7: return (A^{W}, B^{W}) [symbol]
indicates data missing or illegible when filed
```

The large PPMM uses O(N^{ω}) operations, where ω is a constant. In most practical implementations, ω is 3. However, the disclosures may use highly optimized open libraries for PPMM, and they significantly reduce the practical timing. For example, in the present disclosure's implementation on CPU with N=212, an N×N square matrix multiplication with OpenBLAS [1] library takes 1.47 seconds, which was faster than the schoolbook implementation by a factor more than 30. It partly implies that the present disclosure's algorithm would be practically faster than any other CCMM algorithms without reduction to PPMM. The importance of reduction to PPMM has also been stressed in [4], but they focused on the PCMM rather than CCMM.

Any improvement in the implementation of PPMM will directly benefit the present disclosure's algorithm. While this invention implemented the present disclosure's algorithm on a CPU, it may be easily adapted to any hardware architecture unless it does not support efficient matrix operations.

Overall, the cost of the present disclosure's CCMM algorithm is four PPMMs (which is O(N³) with BLAS libraries) with Õ(N²) operations for others. For CCMM between d*d matrices where d>N, the disclosures use block approach, and the cost would be Õ((d/N)^{ω}^{₁}N^{ω}^{₀}) Where ω₀ is the constant for PPMM, in which typically ω₀=3 if the disclosures use BLAS libraries, and ω₁ is a constant for block approach, in which ω₁=log₂ 7 if the disclosures use Strassen algorithm [40].

Moduli consumption and fusing CCMM with bootstrapping. If the disclosures use the fastest matrix transposition algorithm (Algorithm 2), Algorithm 3 requires O(N) switching keys. However, each key is small, as the disclosures may use the switching keys with almost the smallest parameters. The present disclosure's CCMM algorithm consumes only one level during multiplication, and the switching keys are sufficient to support key switching at level 1.

The present disclosure's matrix multiplication algorithms are done in coefficient-encodings. The ciphertexts are coefficient-encoded at the lowest moduli when using FHE with the current fastest bootstrapping methods (S2C-first bootstrapping). Consequently, the disclosures may perform the present disclosure's CCMM algorithm in the lowest modulus while utilizing the fast S2C-first bootstrapping algorithms, as in the case of the state-of-the-art PCMM in [4].

### 4.3 Encoding Structure: Row or Column

Algorithm 3 takes two row-wise encryptions of matrices as inputs and outputs a row-wise encryption of the product. However, it is easy to generalize it to column-wise encrypted inputs and outputs (or even to column-wise inputs and row-wise outputs, and vice versa). In general, the consistent structure of input and output encryptions (e.g., both row-wise encryption or both column-wise encryption) is advantageous for easier implementation in general applications. The disclosures note that the present disclosure's algorithms are flexible in choosing the encoding structure of inputs and outputs as the disclosures have an efficient CMT algorithm.

One interesting scenario is that when the disclosures have column-wise encryption of U and row-wise encryption of V. Then, the disclosures may complete CCMM with two CMTs rather than three, skipping the first CMT (line 1 in Algorithm 3). More importantly, this gives flexibility on the shapes of U and V: Algorithm 3 with omitting line 1 works well with N×n matrix U and n×N matrix V for 1<n<N.

### 5 Lightweight Algorithms with Small Key Size

One of the possible concerns about Algorithms 2 and 3 is the key size. Without optimization, Algorithms 2 and 3 require N switching keys for all automorphisms.

Many switching keys might be acceptable for large devices, as all keys may have small parameters. Since Algorithm 2 does not consume any modulus, the disclosures may assume that all input ciphertexts are in the low modulus (e.g., less than 64-bits primes), with the low ring degree (e.g., N=2¹²). For example, the disclosures may transpose at the bottom modulus and recover the moduli using HalfBTS as in PCMM [4]. Thus, each key for CMT and CCMM is smaller than other keys for homomorphic computation, and N switching keys might be affordable. However, even with the small parameters, N switching keys might not be affordable for small devices.

In this section, the disclosures introduce “lightweight” algorithms with small key sizes for CMT and CCMM. With a slight modification, they are based on Algorithms 2 and 3.

### 5.1 Lightweight CMT Algorithm

In Algorithm 2, the disclosures use N switching keys for N homomorphic automorphisms, applied sequentially (line 2-5 in Algorithm 2). To reduce the key size, the present disclosure's lightweight algorithm uses a single switching key, which is updated before each use. This is possible because in RLWE-based FHE schemes, a switching key is a tuple of ciphertexts, and the disclosures may update it by using another switching key. This observation was also introduced in [30] to reduce the communication cost during key setup. Building on this idea, the disclosures further reduce both the communication cost and the on-chip memory requirements for switching keys in CMT and CCMM algorithms.

For ease of discussion, assume the gadget rank of switching keys is 1. The fundamental observation is that the switching key is an encryption of P*sk (X2t+1) for each t G [N], where P is a constant auxiliary modulus for key switchings. Following the conventional encoding structure of CKKS, the set of all switching keys is

$${\{ Enc ( P \cdot sk ( {X}^{{5}^{′}} ) ) \}}_{i ∈ [ N / 2 ]} ⋃ {\{ Enc ( P \cdot sk ( {X}^{- {5}^{′}} ) ) \}}_{i ∈ [ N / 2 ]} .$$

Consequently, the disclosures may generate another switching key from a given switching key by performing automorphism to the given switching key. If the disclosures have two master rotation keys (Enc(PP′−sk (X5)) and Enc(PP′−sk(X−1)) and an initial switching key Enc(P·sk(X)), the disclosures may generate all switching keys. Where P′ is an auxiliary modulus for generating the key.

In Algorithm 2, the disclosures sequentially use the switching keys in the loop 2-5. Using the above technique, the disclosures may use a single switching key by repeatedly updating it. The switching key is initially set to Enc(P·sk(X)) For the first N/2 iterations, the disclosures use the key and update it using the master rotation key Enc(PP′·sk(X⁵)). Precisely, for each i-th loop, the switching key will be updated to Enc(P·sk(X⁵^{ⁱ}). After N/2 iterations, the disclosures update the switching key using the master conjugation key Enc(PP′·sk(X⁻¹)) and continue the last N/2 iterations. In particular, for each (i+N/2)th loop, the switching key will be updated to Enc(P·sk(X⁻⁵^{ⁱ}).

With the above strategy, the disclosures may exploit only three switching keys. This significantly reduces the key size. The computational cost would increase since N additional key switchings have been introduced. However, the disclosures stress that the asymptotic complexity is still Õ(N²) In the case with a gadget rank dnum larger than 1, the disclosures have the same result by repeating the above procedures for dnum times.

### 5.2 Lightweight CCMM Algorithm

The CMT algorithm with a small key size directly implies a CCMM algorithm with a small key size. The disclosures note that in Algorithm 3, the disclosures used CMT in a black-box manner, and the disclosures may adopt lightweight CMT to achieve a small key size.

With this modification, the present disclosure's lightweight CCMM algorithm requires four switching keys: one for relinearization, one for automorphisms, and two for updating the automorphism key. This modification might increase the cost of CMT by a small constant factor, but it is still minor compared to the cost of PPMM (line 2 in Algorithm 3).

### 6 Experiments

The disclosures implement the present disclosure's algorithms with HEaaN CKKS library [25]. For the matrix multiplication, the disclosures use FLINT library to implement modular matrix multiplications. All experiments are measured on an Intel Xeon Gold 6242 CPU running at 2.80 GHz, using a single thread. The HEaaN library takes advantage of the AVX512 instruments.

For the accuracy, the disclosures measured the relative error bit. Precisely, if the ideal output matrix is W and the experimental result is W′, the disclosures measured

$$- {log}_{2} ( {max}_{i} {‖ {W}_{i} - {W}_{i}^{′} ‖}_{∞} / {max}_{i} {‖ {W}_{i} ‖}_{∞} ) ,$$

where each Mi indicates the i-th row of matrix M.

For the key size, the disclosures calculated it as:

$$N \cdot dnum \cdot {log}_{2} PQ ,$$

where N is the RLWE ring degree, PQ is the modulus that the key switching occurs, and dnum is the rank of the gadget decomposition of the key.

Here, the disclosures assumed the a parts of the keys are from an output of an extendable output-format function (XOF) on public seeds. Then, the disclosures may send or store the keys without the a part. Note that the disclosures exclude the cost of sending seed, as it is relatively minor, and the disclosures may use a counter to use one seed for multiple keys. This technique has been introduced in the literature, such as [10, 5].

### 6.1 CMT Algorithm

The disclosures present the experimental results of CMT algorithms with the present disclosure's proof-of-concept implementations. The disclosures transpose N ciphertexts that each encrypt a random vector from [−1,1] N in its coefficients.

TABLE 1
Parameters for CMT experiments.

| Parameter | log₂ N | log₂ Q | log Δ | log₂ (QP) | dnum | hwt |
|---|---|---|---|---|---|---|
| FST11 | 11 | 26 | 24 | 52 | 1 | 256 |
| LT12 | 12 | 28 | 27 | (64, 104) | (1, 2) | 256 |

Parameter selection. The disclosures conducted experiments on two parameter sets. The parameters are presented in Table 1. All parameters are ˜128-bit secure based on [2].

In Table 1, N is the ring degree of RLWE ciphertexts, and QP is the modulus at which key switchings occur. Q is the ciphertext modulus, and dnum is the rank of the gadget decomposition of key switchings. A is the scaling factor, and hwt is the hamming weight of secret keys.

For QP and dnum of Lt12 parameter, the first entries are used for homomorphic automorphisms, and the second entries are used for updating the key.

Experimental results. The disclosures report the timing and the accuracy of the CMT algorithms in Table 2. The first two rows present the results of Algorithm 2, and the third row shows the results of the lightweight CMT algorithm (Section 5.1). The disclosures take the average of latency and accuracy among 100 experiments.

TABLE 2
Experimental results of CMT algorithms on d × d matrices

| Parameter | d | Latency (s) | Accuracy (bit) | Key size (MB) |
|---|---|---|---|---|
| F_{ST}11 | 2 048 | 0.764 | 10.7 | 27.3 |
| L_{T}12 | 4 096 | 3.04 | 16.3 | 134 |
| L_{T}12* | 4 096 | 4.92 | 14.2 | 0.246 |

The result on the parameter Fst11 takes less than a second to transpose a large matrix of size 2 048×2 048. As it uses relatively small FHE parameters, the key size is reasonable (less than 30 MB) without the lightweight algorithm. The first two rows experimentally show that the CMT algorithm has Õ(N²) complexity, as Lt12 is slower than Fst11 by a factor 4. The last two rows show the impact of the lightweight algorithm. The lightweight algorithm mildly degrades performance while allowing a more than 540 times smaller key size, from 134 MB to 0.25 MB.

### 6.2 CCMM Algorithm

The disclosures describe the experimental results of the ciphertext matrix multiplication algorithm with the present disclosure's proof-of-concept implementations. The disclosures multiplied two vectors of ciphertexts of length N that each vector encrypts the rows of a random N×N matrix in [−1, 1] N×N.

Parameter selection. The disclosures conducted experiments on two parameter sets. The parameters are presented in Table 3. All parameters are *128-bit secure based on [2].

TABLE 3
Parameters for CCMM experiments.

| Parameter | log2 N | log2 Q | log Δ | log2 (QP) | dnum | hwt |
|---|---|---|---|---|---|---|
| FST12 | 12 | (64, 36) | 28 | 104 | 2 | 256 |
| Lr13 | 13 | (66, 38) | 28 | (117, 178) | (2, 3) | 256 |

In Table 3, as in Table 1, N is the ring degree of RLWE ciphertexts, and dnum is the rank of the gadget decomposition of key switchings. A is the scaling factor, and hwt is the hamming weight of secret keys. Q is the ciphertext modulus. Note that the CCMM algorithm contains rescale procedures, and the input and output ciphertext moduli are different. In Table 3, the first entry of log Q indicates the modulus of input ciphertexts, and the second entry is that of output ciphertexts. QP is the modulus at which key switchings occur. For QP and dnum of Lt13 parameter, the first and second entries are used for homomorphic automorphisms and updating the key, respectively.

Experimental results. The disclosures report the measured timing and the accuracy in Table 4 and 5 with the key size. In Table 4, the disclosures present the total latency, accuracy, and the key size of the CCMM algorithm. The first two rows present the results of Algorithm 3, and the third reports the results of the lightweight CCMM algorithm (Section 5.2). The disclosures take the average of latency and accuracy among 10 experiments.

TABLE 4
Experimental results of CCMM algorithms for
multiplying two encrypted d × d matrices.

| Parameter | d | Latency (s) | Accuracy (bit) | Key size (MB) |
|---|---|---|---|---|
| F_{ST}12 | 4 096 | 85.2 | 18.7 | 436 |
| L_{T}13 | 8 192 | 596 | 18.5 | 1 960 |
| L_{T}13* | 8 192 | 672 | 18.5 | 1.57 |

The result for Fst12 parameter shows that multiplying two encrypted 4096×4096 matrices takes less than 1.5 minutes. The results for Lt13 parameter demonstrate the impact of the lightweight algorithm. The lightweight algorithm reduces the key size by a factor of over 1 200, from 1.96 GB to 1.57 MB. Notably, the performance degradation in the lightweight CCMM algorithm is less significant than in CMT, as the cost of CMT during CCMM is relatively minor compared to that of PPMM.

In Table 5, the disclosures report the timing of each step in the CCMM algorithm. In the first column (Transpose), the disclosures present the latency of three transposes (line 1, 3, and 4 of Algorithm 3), and in the second column, the disclosures present the latency of PPMM with FLINT library (line 2 of Algorithm 3). In the third and fourth columns (Relin and Rescale, respectively), the disclosures report the latency of relinearization (line 5) and rescale (line 6), respectively.

TABLE 5
Timing of each step of CCMM algorithm.

| | Latency of each step (s) | | | | |
|---|---|---|---|---|---|
| Parameter | Transpose | PP-MM | Relin | Rescale | Total (s) |
| F_{ST}12 | 25.5 | 57.1 | 1.36 | 1.22 | 85.2 |
| L_{T}13 | 104 | 481 | 6.11 | 5.71 | 596 |
| L_{T}13* | 186 | 474 | 6.28 | 5.51 | 672 |

The disclosures stress that the PPMM step was the heaviest step of the present disclosure's ciphertext matrix multiplication. Improvements in the clear matrix multiplication implementation, e.g., improvements in the linear algebra libraries or adopting GPU or a better hardware architecture for modular matrix multiplication, will directly benefit the present disclosure's algorithm.

In Table 6, the disclosures provide the timing of clear floating-point matrix multiplication, PCMM, and CCMM. The floating-point matrix multiplication uses OpenBLAS library [1], and the numbers for PCMM are borrowed from [4].

TABLE 6
Timing of matrix multiplications in a single
thread. All timings are given in seconds.

| Matix | PP-MM | PC-MM | CC-MM |
|---|---|---|---|
| dimension | ([oBlv]) | ([BCH⁺24]) | (Ours) |
| 4 096 | 1.47 | 17.1 | 85.2 |
| 8 192 | 11.4 | 64.6 | 596 |

The disclosures note that the present disclosure's reduction from CCMM is to modular PPMM rather than floating-point PPMM. There is a notable gap between floating-point PPMM and modular PPMM timings. For example, for matrix dimension 4 096, modular PPMM takes 14.3 seconds in the present disclosure's machine, while floating-point PPMM takes 1.47 seconds.

Table 6 demonstrates the efficiency of the present disclosure's CCMM algorithm, which processes large matrices in minutes. In contrast, based on estimates, existing works would take tens of hours to process matrices of this size. The performance of the present disclosure's approach significantly reduces the gap between CCMM and PCMM or PPMM, demonstrating its practicality in real-world applications.

### REFERENCES

[1] optimized BLAS library version 0.3.26, O. A.: Available at https://www.openblas.net/[2]
Albrecht, M. R., Player, R., Scott, S.: On the concrete hardness of learning with errors. J. Math. Cryptol. (2015), software available at https://github.com/malb/lattice-estimator, git commit #5350825
[3] Anderson, E., Bai, Z., Bischof, C., Blackford, S., Demmel, J., Dongarra, J., Du Croz, J., Greenbaum, A., Hammarling, S., McKenney, A., Sorensen, D.: LAPACK Users' Guide. Society for Industrial and Applied Mathematics, Philadelphia, PA, third edn. (1999)
[4] Bae, Y., Cheon, J. H., Hanrot, G., Park, J. H., Stehle', D.: Plaintext-ciphertext matrix multiplication and FHE bootstrapping: Fast and fused. In: CRYPTO (2024)
[5] Bae, Y., Cheon, J. H., Kim, J., Park, J. H., Stehle', D.: HERMES: efficient ring packing using MLWE ciphertexts and application to transciphering. In: CRYPTO (2023)
[6] Bajard, J. C., Eynard, J., Hasan, M. A., Zucca, V.: A full ms variant of fv like somewhat homomorphic encryption schemes. In: SAC. pp. 423-442. Springer (2016)
[7] Brakerski, Z.: Fully homomorphic encryption without modulus switching from classical gapSVP. In: CRYPTO (2012)
[8] Brakerski, Z., Gentry, C., Vaikuntanathan, V.: (Leveled) fully homomorphic encryption without bootstrapping. ACM Trans. Comput. Theory (2014)
[9] Brakerski, Z., Langlois, A., Peikert, C., Regev, O., Stehle'D.: Classical hardness of learning with errors. In: STOC (2013)
[10] Chen, H., Dai, W., Kim, M., Song, Y.: Homomorphic conversion between (ring) LWE ciphertexts. In: ACNS (2021)
[11] Chen, J., Yang, L., Wu, W., Liu, Y., Feng, Y.: Homomorphic matrix operations under bicyclic encoding (2024), available at https://chen-jingwei.github.io/download/hemm.pdf
[12] Cheon, J. H., Kim, A., Kim, M., Song, Y.: Homomorphic encryption for arithmetic of approximate numbers. In: ASIACRYPT (2017)
[13] Cheon, J. H., Han, K., Kim, A., Kim, M., Song, Y.: Bootstrapping for approximate homomorphic encryption. In: EUROCRYPT. pp. 360-384. Springer (2018)
[14] Cheon, J. H., Han, K., Kim, A., Kim, M., Song, Y.: A full rns variant of approximate homomorphic encryption. In: SAC. pp. 347-368. Springer (2019)
[15] Chillotti, I., Gama, N., Georgieva, M., Izabache'ne, M.: Faster packed homomorphic operations and efficient circuit bootstrapping for TFHE. In: ASIACRYPT (2017)
[16] Devlin, J., Chang, M. W., Lee, K., Toutanova, K.: BERT: Pre-training of deep bidirectional transformers for language understanding (2018), available at https://arxiv.org/abs/1810.04805
[17] Ducas, L., Micciancio, D.: Fhew: bootstrapping homomorphic encryption in less than a second. In: EUROCRYPT. pp. 617-640. Springer (2015)
[18] Fan, J., Vercauteren, F.: Somewhat practical fully homomorphic encryption. Available at http://eprint.iacr.org/2012/144 (2012)
[19] Gao, Y., Quan, G., Homsi, S., Wen, W., Wang, L.: Secure and efficient general matrix multiplication on cloud using homomorphic encryption. The Journal of Supercomputing (2024)
[20] Gentry, C., Halevi, S., Vaikuntanathan, V.: A simple bgn-type cryptosystem from lwe. In: EUROCRYPT (2010)
[21] Goldwasser, S., Kalai, Y. T., Peikert, C., Vaikuntanathan, V.: Robustness of the learning with errors assumption. In: ICS (2010)
[22] Gunther, M., Schutze, L., Becher, K., Strufe, T., Castrillon, J.: Helium: A language and compiler for fully homomorphic encryption with support for proxy re-encryption, arXiv preprint arXiv:2312.14250 (2023)
[23] Han, K., Ki, D.: Better bootstrapping for approximate homomorphic encryption. In: Cryptographers' Track at the RSA Conference (2020)
[24] Hao, M., Li, H., Chen, H., Xing, P., Xu, G., Zhang, T.: Iron: Private inference on transformers. Advances in Neural Information Processing Systems (2022)
[25] HEaaN, C.: HEaaN library (2022), available at https://www.cryptolab.co.kr/en/products-en/heaan-he/
[26] Hong, S., Choi, Y. A., Joo, D. S., Gursoy, G.: Privacy-preserving model evaluation for logistic and linear regression using homomorphically encrypted genotype data. Journal of biomedical informatics (2024)
[27] Huang, Z., Hong, C., Weng, C., Lu, W., Qu, H.: More efficient secure matrix multiplication for unbalanced recommender systems. IEEE Transactions on Dependable and Secure Computing (2021)
[28] Jiang, X., Kim, M., Lauter, K., Song, Y.: Secure outsourced matrix computation and application to neural networks. In: CCS (2018)
[29] Langlois, A., Stehle', D.: Worst-case to average-case reductions for module lattices. Des. Codes Cryptogr. (2015)
[30] Lee, J. W., Lee, E., Kim, Y. S., No, J. S.: Rotation key reduction for client-server systems of deep neural network on fully homomorphic encryption. In: ASIACRYPT (2023)
[31] Liu, J., Zhang, L. F.: Privacy-preserving and publicly verifiable matrix multiplication. IEEE Transactions on Services Computing (2022)
[32] Lyubashevsky, V., Peikert, C., Regev, O.: On ideal lattices and learning with errors over rings. In: EUROCRYPT (2010)
[33] Ma, X., Ma, C., Jiang, Y., Ge, C.: Improved privacy-preserving pca using optimized homomorphic matrix multiplication. Computers & Security (2024)
[34] Micciancio, D., Sorrell, J.: Ring packing and amortized FHEW bootstrapping. In: ICALP (2018)
[35] Mouchet, C., Troncoso-Pastoriza, J., Bossuat, J. P., Hubaux, J. P.: Multiparty homomorphic encryption from ring-learning-with-errors. Proceedings on Privacy Enhancing Technologies 2021 (4), 291-311 (2021)
[36] Pang, Q., Zhu, J., Mollering, H., Zheng, W., Schneider, T.: Bolt: Privacy-preserving, accurate and efficient inference for transformers. In: 2024 IEEE Symposium on Security and Privacy (SP) (2024)
[37] Peikert, C., Waters, B.: Lossy trapdoor functions and their applications. In: STOC (2008)
[38] Radford, A., Narasimhan, K., Salimans, T., Sutskever, I.: Improving language understanding by generative pre-training (2018), available at https://openai.com/research/language-unsupervised
[39] Stehlè D., Steinfeld, R., Tanaka, K., Xagawa, K.: Efficient public key encryption based on ideal lattices. In: ASIACRYPT (2009)
[40] Strassen, V.: Gaussian elimination is not optimal. Numerische mathematik 13(4), 354-356 (1969)
[41] team, T. F.: FLINT: Fast Library for Number Theory (2024), version 3.2.0-dev, https://flintlib.org-commit #c29a090
[42] Touvron, H., Lavril, T., Izacard, G., Martinet, X., Lachaux, M. A., Lacroix, T., Rozière, B., Goyal, N., Hambro, E., Azhar, F., Rodriguez, A., Joulin, A., Grave, E., Lample, G.: LLaMA: Open and efficient foundation language models (2023), available at https://arxiv.org/abs/2302.13971
[43] Zhang, J., Liu, J., Yang, X., Wang, Y., Chen, K., Hou, X., Ren, K., Yang, X.: Secure transformer inference made non-interactive (2023), available at https://eprint.iacr.org/2024/136
[44] Zheng, X., Li, H., Wang, D.: A new framework for fast homomorphic matrix multiplication (2023), available at https://eprint.iacr.org/2023/1649
[45] Zhu, W., Li, X.: Secure mutual learning with low interactions for deep model training. In: International Conference on Mobility, Sensing and Networking (2023)

The methods according to the various embodiments of the present disclosure described above may be implemented in the form of an application capable of being installed on a conventional electronic apparatus.

The methods according to the various embodiments of the present disclosure described above may be implemented only by software upgrade or hardware upgrade of the conventional electronic apparatus.

The various embodiments of the present disclosure described above may also be performed through an embedded server included in the electronic apparatus, or an external server of at least one of the electronic apparatus or a display device.

According to an embodiment of the present disclosure, the various embodiments described above may be implemented in software including an instruction stored on a machine-readable storage medium (for example, a computer-readable storage medium). A machine may be a device that invokes the stored instruction from a storage medium, may be operated based on the invoked instruction, and may include the electronic apparatus according to the disclosed embodiments. If the instruction is executed by the processor, the processor may directly perform a function corresponding to the instruction or other components may perform the function corresponding to the instruction under control of the processor. The instruction may include codes provided or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored on the storage medium.

According to an embodiment of the present disclosure, the methods according to the various embodiments described above may be included and provided in a computer program product. The computer program product may be traded as a commodity between a seller and a purchaser. The computer program product may be distributed in a form of the machine-readable storage medium (for example, a compact disc read only memory (CD-ROM)), or may be distributed online through an application store. In case of the online distribution, at least a part of the computer program product may be at least temporarily stored or temporarily provided on a storage medium such as the memory of a manufacturer server, an application store server, or a relay server.

Each of the components (for example, modules or programs) according to the various embodiments described above may include a single entity or a plurality of entities, and some of the corresponding sub-components described above may be omitted or other sub-components may be further included in the various embodiments. Alternatively or additionally, some of the components (for example, the modules or the programs) may be integrated into the single entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

Although the embodiments are shown and described in the present disclosure as above, the present disclosure is not limited to the above-described specific embodiments, and may be variously modified by those skilled in the art to which the present disclosure pertains without departing from the gist of the present disclosure as claimed in the accompanying claims. These modifications should also be understood to fall within the scope and spirit of the present disclosure.

### DESCRIPTION OF REFERENCE NUMERALS

100: electronic apparatus
110: processor
120: memory

1. An electronic apparatus comprising:
at least one processor including processing circuitry; and
a memory storing instructions,
wherein the at least one processor is configured to
obtain an operation command for performing a first multiplication operation on a first ciphertext matrix and a second ciphertext matrix,
obtain a third ciphertext matrix by applying a ciphertext matrix transpose (CMT) algorithm to the first ciphertext matrix, and
obtain an operation result corresponding to the operation command by performing a second multiplication operation on a plurality of plaintext matrices based on the second ciphertext matrix and the third ciphertext matrix.

2. The apparatus as claimed in claim 1, wherein the ciphertext matrix transpose (CMT) algorithm is an algorithm for transforming row-based data into column-based data or vice versa.

3. The apparatus as claimed in claim 1, wherein the first ciphertext matrix includes a first plaintext matrix, a first Toeplitz (Toep) matrix, and a second plaintext matrix, and
the second ciphertext matrix includes a third plaintext matrix, the first Toeplitz matrix, and a fourth plaintext matrix.

4. The apparatus as claimed in claim 3, wherein the at least one processor is configured to obtain the third ciphertext matrix, which includes the first plaintext matrix, the second plaintext matrix, and a second Toeplitz matrix by applying the ciphertext matrix transpose (CMT) algorithm to the first ciphertext matrix.

5. The apparatus as claimed in claim 4, wherein the first Toeplitz matrix and the second Toeplitz matrix are matrices having the same values in a predetermined diagonal direction.

6. The apparatus as claimed in claim 4, wherein the first Toeplitz matrix is a matrix generated based on a first secret key, and
the second Toeplitz matrix is a matrix generated based on a second secret key that is different from the first secret key.

7. The apparatus as claimed in claim 6, wherein the second secret key is a key that is an automorphism of the first secret key.

8. The apparatus as claimed in claim 4, wherein the at least one processor is configured to obtain the operation result by performing the second multiplication operation on at least two plaintext matrices among the first plaintext matrix, the second plaintext matrix, the third plaintext matrix, and the fourth plaintext matrix.

9. The apparatus as claimed in claim 4, wherein the at least one processor is configured to obtain a first data group based on the second ciphertext matrix and the third ciphertext matrix, and
the first data group includes first data, second data, third data, and fourth data,
the first data including the second Toeplitz matrix, the first plaintext matrix, the third plaintext matrix, and the first Toeplitz matrix,
the second data including the second Toeplitz matrix, the first plaintext matrix, and the fourth plaintext matrix,
the third data including the second plaintext matrix, the third plaintext matrix, and the first Toeplitz matrix, and
the fourth data including the second plaintext matrix and the fourth plaintext matrix.

10. The apparatus as claimed in claim 9, wherein the at least one processor is configured to
obtain a fifth plaintext matrix by multiplying the first plaintext matrix with the third plaintext matrix,
obtain a sixth plaintext matrix by multiplying the first plaintext matrix with the fourth plaintext matrix,
obtain a seventh plaintext matrix by multiplying the second plaintext matrix with the third plaintext matrix,
obtain an eighth plaintext matrix by multiplying the second plaintext matrix with the fourth plaintext matrix, and
obtain a second data group based on the fifth plaintext matrix, the sixth plaintext matrix, the seventh plaintext matrix, and the eighth plaintext matrix, and
the second data group includes fifth data, sixth data, seventh data, and eighth data,
the fifth data including the second Toeplitz matrix, the fifth plaintext matrix, and the first Toeplitz matrix,
the sixth data including the second Toeplitz matrix and the sixth plaintext matrix,
the seventh data including the seventh plaintext matrix and the first Toeplitz matrix, and
the eighth data including the eighth plaintext matrix.

11. A controlling method of an electronic apparatus, the method comprising:
obtaining an operation command for performing a first multiplication operation on a first ciphertext matrix and a second ciphertext matrix;
obtaining a third ciphertext matrix by applying a ciphertext matrix transpose (CMT) algorithm to the first ciphertext matrix; and
obtaining an operation result corresponding to the operation command by performing a second multiplication operation on a plurality of plaintext matrices based on the second ciphertext matrix and the third ciphertext matrix.

12. The method as claimed in claim 11, wherein the ciphertext matrix transpose (CMT) algorithm is an algorithm for transforming row-based data into column-based data or vice versa.

13. The method as claimed in claim 11, wherein the first ciphertext matrix includes a first plaintext matrix, a first Toeplitz (Toep) matrix, and a second plaintext matrix, and
the second ciphertext matrix includes a third plaintext matrix, the first Toeplitz matrix, and a fourth plaintext matrix.

14. The method as claimed in claim 13, wherein in the obtaining of the third ciphertext matrix,
the third ciphertext matrix, which includes the first plaintext matrix, the second plaintext matrix, and a second Toeplitz matrix is obtained by applying the ciphertext matrix transpose (CMT) algorithm to the first ciphertext matrix.

15. The method as claimed in claim 14, wherein the first Toeplitz matrix and the second Toeplitz matrix are matrices having the same values in a predetermined diagonal direction.

16. The method as claimed in claim 14, wherein the first Toeplitz matrix is a matrix generated based on a first secret key, and
the second Toeplitz matrix is a matrix generated based on a second secret key that is different from the first secret key.

17. The method as claimed in claim 16, wherein the second secret key is a key that is an automorphism of the first secret key.

18. The method as claimed in claim 14, wherein in the obtaining of the operation result,
the operation result is obtained by performing the second multiplication operation on at least two plaintext matrices among the first plaintext matrix, the second plaintext matrix, the third plaintext matrix, and the fourth plaintext matrix.

19. The method as claimed in claim 14, wherein in the obtaining of the operation result, a first data group is obtained based on the second ciphertext matrix and the third ciphertext matrix, and
the first data group includes first data, second data, third data, and fourth data,
the first data including the second Toeplitz matrix, the first plaintext matrix, the third plaintext matrix, and the first Toeplitz matrix,
the second data including the second Toeplitz matrix, the first plaintext matrix, and the fourth plaintext matrix,
the third data including the second plaintext matrix, the third plaintext matrix, and the first Toeplitz matrix, and
the fourth data including the second plaintext matrix and the fourth plaintext matrix.

20. The method as claimed in claim 19, wherein in the obtaining of the operation result,
a fifth plaintext matrix is obtained by multiplying the first plaintext matrix with the third plaintext matrix,
a sixth plaintext matrix is obtained by multiplying the first plaintext matrix with the fourth plaintext matrix,
a seventh plaintext matrix is obtained by multiplying the second plaintext matrix with the third plaintext matrix,
an eighth plaintext matrix is obtained by multiplying the second plaintext matrix with the fourth plaintext matrix, and
a second data group is obtained based on the fifth plaintext matrix, the sixth plaintext matrix, the seventh plaintext matrix, and the eighth plaintext matrix, and
the second data group includes fifth data, sixth data, seventh data, and eighth data,
the fifth data including the second Toeplitz matrix, the fifth plaintext matrix, and the first Toeplitz matrix,
the sixth data including the second Toeplitz matrix and the sixth plaintext matrix,
the seventh data including the seventh plaintext matrix and the first Toeplitz, matrix, and
the eighth data including the eighth plaintext matrix.
